(19) United States
(12) Patent Application Publication
(10) Pub. No.: US 2025/0165867 A1
(43) Pub. Date: May 22, 2025

(54) DOMAIN-AGNOSTIC MIXED-STRUCTURE SYSTEM FOR AUGMENTING SUBJECT MATTER EXPERT HUMAN INTELLIGENCE WITH GENERATIVE ARTIFICIAL INTELLIGENCE TO SUPPORT THE SCALABLE OPTIMIZATION OF COMPLEX PHENOMENA

(71) Applicant: Exaptive, Inc., Oklahoma City, OK (US)

(72) Inventors: David King, Oklahoma City, OK (US); Kent Morgan, Oklahoma City, OK (US); Cory White, Oklahoma City, OK (US)

(21) Appl. No.: 18/953,853

(22) Filed: Nov. 20, 2024

Related U.S. Application Data
(60) Provisional application No. 63/601,060, filed on Nov. 20, 2023.

(51) Int. Cl. G06N 20/00

(52) U.S. Cl. CPC G06N 20/00

(57) ABSTRACT

A system is herein disclosed. The system comprises a processor and a memory having instructions causing the processor to: receive a model definition for a domain model having model components; associate the model components with a prompt template having a placeholder; associate the prompt template with an AI service and store settings associated with a service response; receive first model data of the model components as a first domain instance; display a named view of the first domain instance; receive an entry point; construct, a dynamic prompt based on the prompt template; orchestrate a CCP containing service calls to the AI service; receive the service response; parse the service response into a structured response with a second model data; generate an augmented model data based on the first model data and the structured response as a second domain instance; and replace the first domain instance with the second domain instance.

### CROSS-REFERENCE TO RELATED APPLICATION

The present patent application claims priority under 35 U.S.C. 119(e) to the provisional patent application identified by U.S. Ser. No. 63/601,060 filed Nov. 20, 2023, titled “DOMAIN-AGNOSTIC MIXED-STRUCTURE SYSTEM FOR AUGMENTING SUBJECT MATTER EXPERT HUMAN INTELLIGENCE WITH GENERATIVE ARTIFICIAL INTELLIGENCE TO SUPPORT THE SCALABLE OPTIMIZATION OF COMPLEX PHENOMENA”, the entire contents of which are expressly incorporated herein by reference.

### BACKGROUND OF THE ART

The idea that technology can augment human intelligence instead of replace human intelligence is not in itself new, however the systems that have reduced this idea to practice up to now have only been able to do so by either making a system so tightly-coupled to the specific problems of a given domain as to prohibit the system's use beyond the specific field for which it was originally designed, or by making the system so general as to offer little additional cognitive benefit to the user beyond simply making the user's own knowledge more readily accessible or making the use of a cumbersome technology slightly less cumbersome.

A good case-study in the implications of highly-specific augmentation systems can be seen in architectural computer-aided design (CAD) systems. When the famous architect, Frank Ghery, tried to use traditional architectural CAD systems to draw the flowing, organic designs which made his architecture unique, the software was unable to support him because it was based on an implicit architectural assumption, built into the core of the software, that buildings were mostly composed of rectangles and that architectural lines were mostly straight. Ghery's technological team ended up producing their designs only by adopting an aerospace CAD system called CATIA, used to design fighter jets, in which the Bezier curve was a first-class concept of the software. Dennis Sheldon, Ghery's Director of Computing, in his PHD thesis submitted to MIT while working for Ghery, wrote: “The relationships between tools, process of making enabled by tools, and the objects produced by operating tools are subtle and deep. The operations enabled by a chosen tool guide the operator to make specific types of objects or products that the tool affords.”

That is, airplane CAD systems will help an aerospace engineer design a plane with curves and architectural CAD systems will help a building architect design a building with lines—both systems successfully using their “artificial intelligence” to augment the human intelligence of their user—only as long as that user operates with the same mental model upon which those tools were built. As soon as the aerospace designer decides to experiment with blocky non-aerodynamic plane shapes, or the building architect decides to experiment with curving aerodynamic building shapes, both systems quickly shift from augmenting the user's intelligence and creativity to hindering the user's intelligence and creativity.

In contrast to highly-specialized systems like those discussed above, there also exist a wide variety of highly-generalized tools that seek to augment human intelligence regardless of domain. However, to avoid the pitfalls that overly-constrained systems suffer from, the systems become overly general. Nobel prize-winning physicist Richard Feynman viewed the blank piece of paper as a general-purpose intelligence augmentation system and argued for it to be viewed this way when he was interviewed by historian Charles Weiner. Weiner had looked over some of Feynman's notebooks and called them a “record of his day-to-day work”. Feynman objected, leading to the following exchange: “They aren't a record of my thinking process. They are my thinking process. I actually did the work on the paper,” Feynman said. “Well,” Weiner said, “The work was done in your head, but the record of it is still here.” “No, it's not a record, not really. It's working. You have to work on paper and this is the paper. Okay?”, Feynman explained.

It is precisely in the nuanced area between highly-specific augmentation systems like Ghery's CAD software and highly-general augmentation systems like Feynman's blank piece of paper that this disclosure is directed.

To better understand why the divide between these two types of systems exist it is instructive to appreciate from the field of complexity theory the difference between things that are complicated and things that are complex. In everyday language we tend to use these words interchangeably but with regard to system design the fundamental difference between the two is critical. In his book on complexity, Rick Nason writes: “Complicated problems can be hard to solve, but they are addressable with rules and recipes, like the algorithms that place ads on your Twitter feed. They also can be resolved with systems and processes, like the hierarchical structure that most companies use to command and control employees.

The solutions to complicated problems do not work as well with complex problems, however. Complex problems involve too many unknowns and too many interrelated factors to reduce to rules and processes. A technological disruption like blockchain is a complex problem. A competitor with an innovative business model—an Uber or an Airbnb—is a complex problem. There is no algorithm that will tell you how to respond.”

This could be dismissed as an exercise in semantics, except for one thing: When facing a problem, says Nason, managers tend to automatically default to complicated thinking.

Just like managers default to complicated thinking, knowledge workers default to using complication-effective tools instead of complexity-effective tools, primarily because so few complexity-effective tools exist. Unfortunately, tools that are good at solving complicated problems tend to be counterproductive when applied to complex problems.

Complicated problems might be hard to solve, but if they are it is because of their scale, not their complexity. Complicated problems have lots of parts to them, but those parts interact with each other in well-defined ways that are easy to reduce to explicit rules. Watches with lots of gears are a quintessential example of something complicated but not complex. Complex problems are hard to solve for completely different reasons.

Complex problems may involve very few parts, but those parts have many nuanced ways of interacting with each other—influencing each other in ways that are hard to reduce down to a set of deterministic rules. Watches are complicated. Getting somewhere on time is complex. Domain-specific, highly-specialized technological augmentation systems like CAD help their users tackle complicated problems. Domain-agnostic, highly-general augmentation systems like old-fashioned paper and pen, or more technologically advanced versions of paper and pen, like digital whiteboards and diagramming software, help their users tackle complex problems.

### SUMMARY OF THE INVENTION

The rise of generative artificial intelligence ushered in by rapid adoption of large language models across many diverse application domains has driven an urgent interest in systems that use such technology to augment human intelligence instead of replace it. While it has in the past been possible to achieve such augmentation by implementing highly-domain-specific systems with a priori knowledge of the domain they augment, it has been an unsolved problem how to implement domain-agnostic systems capable of augmenting, in a scalable way, a subject matter expert's (SME) investigation of an arbitrary problem of their own definition using general-purpose AI services instead of custom fine-tuned ones. This disclosure describes a method of implementing such a system and shows the systems' operation on problems both in the sciences and the humanities with no a priori knowledge of the problem other than what is made explicit by the SME through the SME's use of the system herein disclosed.

All IA systems, at their highest level, are designed to combine two types of contributions-contributions from the human user that embody some form of human intelligence (HI) and contributions from technology that embody some form of artificial intelligence (AI). These contributions, at the highest level, can only take one of two forms: as either structured or unstructured data. There are therefore only 4 possible types of IA systems based on the permutations of these two types of contributions:
Type-1. Structured HI contributions augmented with structured AI contributions.
Type-2. Structured HI contributions augmented with unstructured AI contributions.
Type-3. Unstructured HI contributions augmented with structured AI contributions.
Type-4. Unstructured HI contributions augmented with unstructured AI contributions.

Type-1 IA systems, structured HI combined with structured AI, are exactly what domain-specific, highly-specialized, systems like CAD are. The rules of the domain (building architecture) and the specific problem being solved within that domain (blueprint for a house) form the structure around which the AI can augment the HI. The user inputs the user's thoughts within that structure (the length and width of the building footprint) and the AI can then operate on the structured data to add value (render the drawing, add supports every X feet, etc.).

Type-4 IA systems, unstructured HI combined with unstructured AI, are exactly what domain-agnostic, highly-general, systems are. They allow the human unfettered input of unstructured representations of the human's thinking, then augment this in simple unstructured ways by storing, transmitting, and summarizing the unstructured input, for example. Because Type-4 IA systems are a very limiting use of technology's augmentation potential, there have been some limited, and not particularly successful, attempts at the creation of Type-3 systems via the evolution of Type-4 systems.

Type-3 IA systems, unstructured HI combined with structured AI contributions, are extremely difficult to implement because of the difficulty of computers offering consistent structured response in response to a wide variety of unstructured HI input. For example, if a Type-4 system is a digital drawing application that simply stores a user's drawing in a persistent digital format, a Type-3 system might be the same drawing application, but one that replaces every hand-drawn circle with a perfect circle and every hand-drawn triangle with a perfect triangle, etc., thus rendering a perfect flowchart from a hand-drawn one. Such systems exist but are extremely error-prone, and by the time the Type-3 system is made robust, the Type-3 system no longer resembles a Type-3 system but, instead, has been replaced by a Type-1 system: as long as the user can input a shape in accordance with the structured rules that allow the computer to know what shape is entered, the computer can augment the drawing with the appropriate structured shape data. Thus, we see few usable Type-3 systems in operation. We similarly see few Type-2 systems, mostly because AI's contribution, prior to the recent rise of generative AI systems, has been highly structured, not unstructured.

This explains the current state of the art while also making clear the open space in IA system design that the disclosed invention fills: currently technologies provide for lots of Type-1 IA systems for helping people solve complicated problems and lots of Type-4 IA systems for helping people explore complex phenomena, but a complete lack of Type-2/3 IA systems that help people explore complex phenomena in structured ways that use both structured and unstructured AI contributions to augment the user's understanding of that complex phenomena and, ultimately, augment the user's ability to find a desired optimal solution to that complex phenomena.

Hereinafter, a “like-structure” (IA) system refers to the Type-1 and Type-4 IA systems because the HI and AI contributions are either both in the form of structured data or both in the form of unstructured data.

Hereinafter, a “mixed-structure” (IA) system refers to the Type-2 and Type-3 IA systems because the HI and AI contributions take opposite forms, that is, in a mixed-structure system, if the HI contribution is considered structured, then the AI contribution is considered unstructured, and vice versa.

This disclosure describes a highly-scalable, domain-agnostic, mixed-structure IA system—the missing middle ground between the overly-specific (or overly structured) and the overly-general (or overly unstructured).

The present disclosure is a product of the times in multiple ways. It is only recently made possible due to a confluence of factors both societal and technological. Society has solved many complicated problems and appears on track to solve many more through continued specialization accompanied with increasing computing power. However, at the same time that society's capacity to solve complicated problems seems to be increasing, society's capacity to tackle complex problems seems to be decreasing. Unfortunately, the most important problems that face us today—insufficiently mitigated climate change, increasing geo-political polarization, sub-optimal pandemic responses, decreasing rates of disruptive innovation across every field—are not complicated problems, but are complex problems.

An increased recognition that complex problems cannot be tamed through the use of the same tools applied to complicated problems provides the impetus for a domain-agnostic, mixed-structure, IA system, as described herein. In parallel, recent advances in generative artificial intelligence (AI), best illustrated by OpenAI's GPT large language model, have shifted AI from only being able to contribute meaningfully to systems in a structured way to now being able to participate meaningfully in unstructured ways, both with AI's ability to receive unstructured data in the form of “prompts” and to respond with meaningful unstructured data in reply.

These new unstructured AI offerings enable construction of a domain-agnostic, mixed-structure IA system. Unstructured AI services are powerful as standalone systems, and Unstructured AI services add new power to preexisting like-structure IA systems, which is how most business have worked to integrate Unstructured AI services into existing products—simply making it easier for the user to call on the AI without having to switch interfaces to ask an unstructured question or review an unstructured response. However, these product integrations are little more than that—integrations. Thus, these product integrations fail to achieve construction of new types of IA systems, like the domain-agnostic, mixed-structure IA system disclosed herein.

Recent advances in artificial intelligence (AI), specifically Large Language Models (LLMs) using Generative Pre-trained Transformers, similar to OpenAI's GPT AI engine, have now made it possible to construct an intelligence augmentation (IA) system that occupies an architectural sweet spot between the highly-specific systems and the highly-general systems described above.

Due to the way that the human intelligence (HI) component is captured in a well-structured format, the “domain model”, along with an unstructured format, the “prompt templates”, and the AI component is captured back in the well-structured format of the domain model despite its native responses being unstructured in nature, systems at this intersection form mixed-structure IA systems for computer-aided problem solving.

### BRIEF DESCRIPTIONS OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a block diagram of an exemplary embodiment of an IA mixed-structure system constructed in accordance with the present disclosure.

FIG. 2 is a flow diagram of an exemplary embodiment of a user workflow constructed in accordance with the present disclosure.

FIG. 3 is a sequence diagram of an AI data population process constructed in accordance with the present disclosure.

FIG. 4 is a screenshot of an exemplary embodiment of a model builder and AI augmentation user interface (UI) implementing the user workflow of FIG. 3.

FIG. 5 is a screenshot of an exemplary embodiment of a new element type modal window of the model builder user interface of FIG. 4.

FIG. 6 is a screenshot of another exemplary embodiment of the model builder user interface displaying an SME model having two element types and the SME creating a new connection type between them.

FIG. 7 is a screenshot of another exemplary embodiment of the model builder user interface displaying a set of complex relationships constructed in accordance with the present disclosure.

FIG. 8 is a screenshot of an exemplary embodiment of the model builder user interface displaying a popup menu constructed in accordance with the present disclosure.

FIG. 9 is a workflow diagram of an exemplary embodiment of data within a configuration user interface constructed in accordance with the present disclosure.

FIG. 10A is a screenshot of an exemplary embodiment of a first complex model constructed within the model builder user interface of FIG. 4.

FIG. 10B is a screenshot of another exemplary embodiment of a second complex model constructed within the model builder user interface of FIG. 4.

FIG. 11 is a screenshot of an exemplary embodiment illustrating association between a model element type with a prompt template and associated AI integration definitions as constructed in accordance with the present disclosure.

FIG. 12 is a model diagram of an exemplary embodiment of an algorithmic exaptation model and its associated AI prompt templates constructed in accordance with the present disclosure.

FIG. 13 is a screenshot of an exemplary embodiment of a data inspection user interface constructed in accordance with the present disclosure.

FIG. 14 is a workflow diagram of an exemplary embodiment of a manual data population user interface constructed in accordance with the present disclosure.

FIG. 15 is a screenshot of an exemplary embodiment of the data inspection user interface of FIG. 13 having manually entered data for the model.

FIG. 16A is a screenshot of an exemplary embodiment of a view builder user interface constructed in accordance with the present disclosure.

FIG. 16B is a screenshot of an exemplary embodiment of a view builder user interface for constructing the query that populates a view constructed within the view builder user interface of FIG. 16A.

FIG. 17 is a screenshot of an exemplary embodiment of a second view of an exaptive model having an entry point and a plurality of element instances constructed within the view builder user interface of FIG. 16A.

FIG. 18 is a screenshot of an exemplary embodiment of an AI augmentation user interface constructed in accordance with the present disclosure.

FIG. 19 is a screenshot of an exemplary embodiment of the AI augmentation user interface of FIG. 18 showing an SME validation user interface constructed in accordance with the present disclosure.

FIG. 20 is a screenshot of an exemplary embodiment of the second view of FIG. 17 showing a plurality of results from multiple AI augmentations at a plurality of entry points as constructed in accordance with the present disclosure.

FIG. 21 is a screenshot of an exemplary embodiment of the second view of FIG. 20 annotated to illustrate source data origination.

FIG. 22 is a screenshot of an exemplary embodiment of the second view of FIG. 20 further having a merge user interface constructed in accordance with the present disclosure.

FIG. 23A-B are screenshots of an exemplary embodiment of the second view of FIG. 20 showing the plurality of results after AI augmentation has traversed the model as constructed in accordance with the present disclosure.

FIG. 24 is an illustration of an exemplary embodiment of descriptions provided by AI augmentation for element instance in the second view as constructed in accordance with the present disclosure.

FIG. 25 is a diagram of an exemplary embodiment of a workflow for connection augmentation constructed in accordance with the present disclosure.

FIG. 26A is a diagram of an exemplary embodiment of a second model constructed in accordance with the present disclosure.

FIG. 26B is a diagram of an exemplary embodiment of a third result view after AI augmentation constructed in accordance with the present disclosure.

FIG. 27 is an illustration of an exemplary embodiment of a user interface showing the construction, execution, and associated costs of a coordinated call package (CCP) constructed in accordance with the present disclosure.

FIG. 28 is a workflow diagram of an exemplary embodiment of a fourth result view after AI augmentation based on the prompt template of FIG. 27.

FIG. 29 is a hardware diagram of an exemplary embodiment of the user device constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value. It is not intended that the scope of the invention be limited to the specific values recited when defining a range. All ranges are inclusive and combinable.

Circuitry, as used herein, may be analog components and/or digital components, or one or more suitably programmed processors (e.g., microprocessors) and associated hardware and software, or hardwired logic. Additionally, “components” may perform one or more functions, or may contribute to performance of one or more functions. As used herein, the term “processing component,” may include hardware such as a processor, a microprocessor, a mobile processor, a system on a chop (SoC), a central processing unit (CPU), a microcontroller (MCU), a digital signal processor (DSP), an application specific integrated circuit (ASIC), a field programmable gate array (FPGA), a Tensor Processing Unit (TPU), a graphics processing unit (GPU), a combination of hardware and software, software, and/or the like. The term “processor” as used herein means a single processing component or multiple processing components working independently or together to collectively perform a task.

Software may include one or more processor-executable instruction that when executed by one or more processing component, e.g., a processor, causes the processing component to perform a specified function. It should be understood that the algorithms described herein may be stored on one or more non-transitory processor-readable medium. Exemplary non-transitory processor-readable media operable to store processor-executable instructions may include a non-volatile memory, a random access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, combinations thereof, and/or the like. Such non-transitory computer-readable media may be electrically based, optically based, magnetically based, resistive based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

The diagrams that follow show how an IA mixed-structure system is capable of using a general-purpose unstructured AI combined with specific-purpose, user-structured models to actively facilitate connections between disparate knowledge areas.

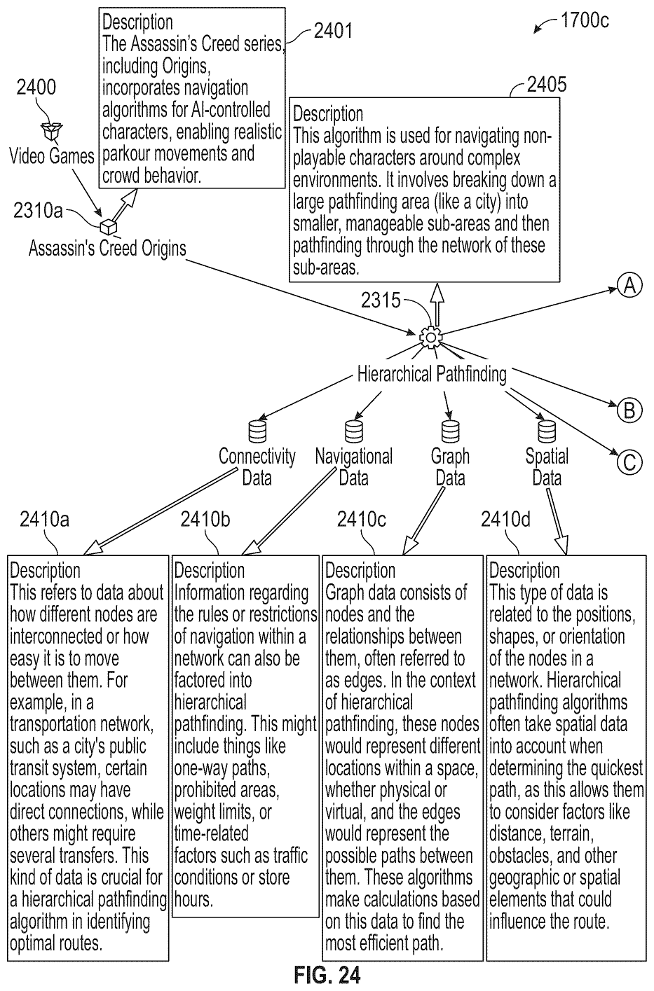

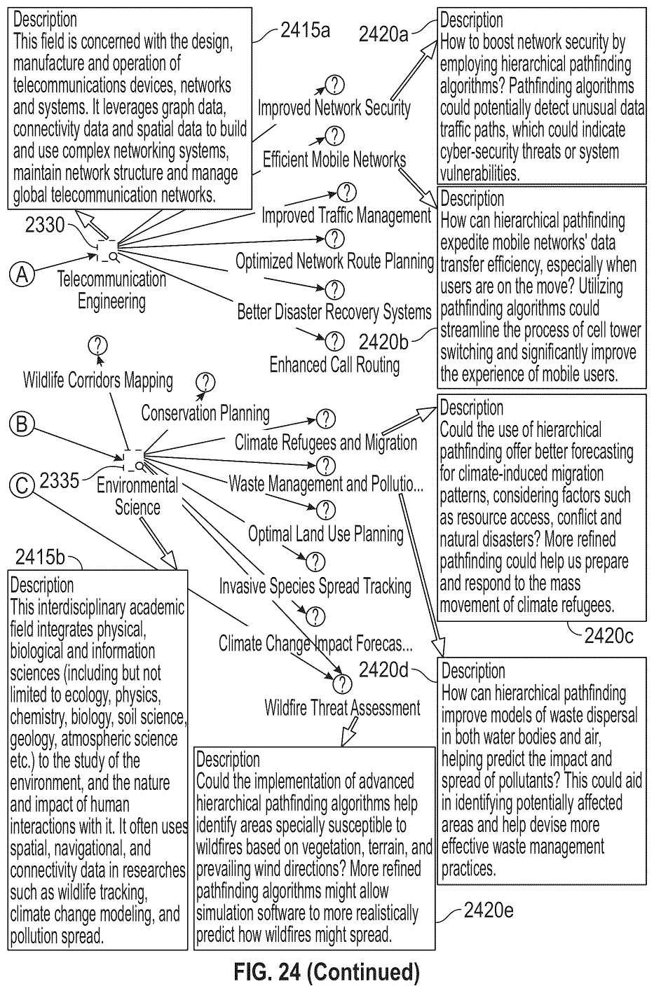

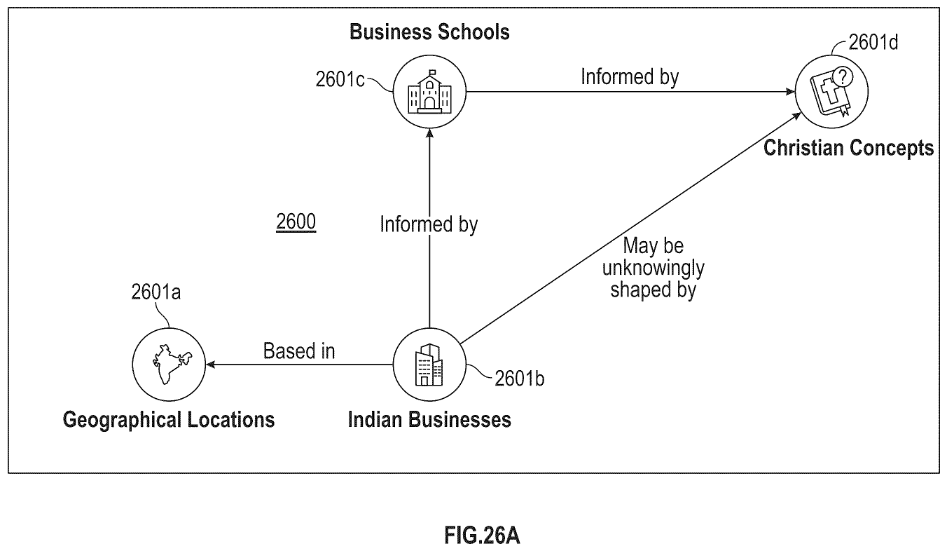

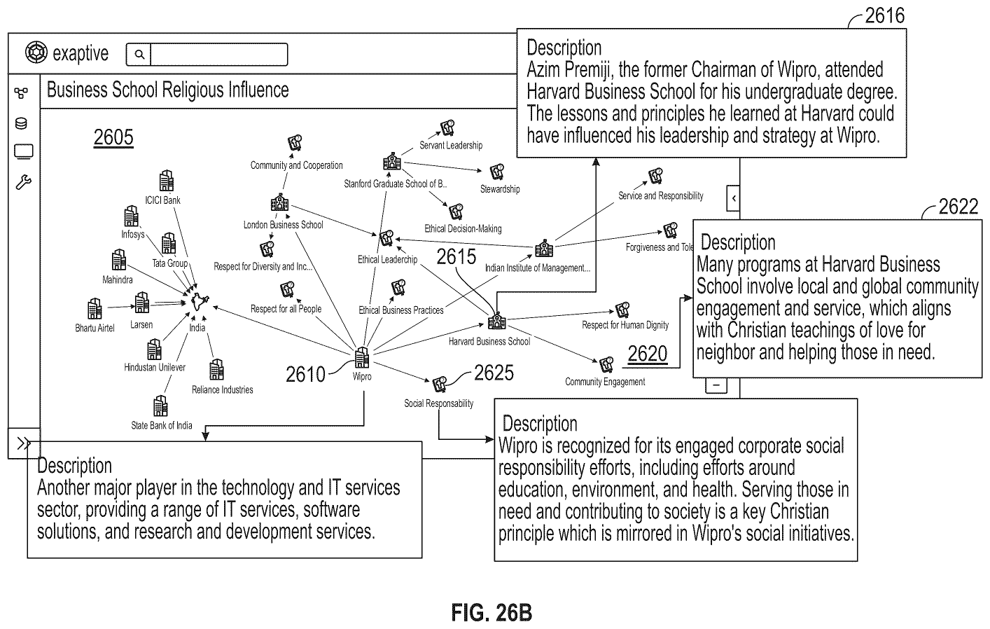

The present disclosure describes a video game algorithmic exaptation as an example of a specific complex problem to which the IA mixed-structure system 90 disclosed can be applied. The present disclosure shows that with less than one hour of use by a trained user a current embodiment of the disclosed invention is able to uncover dozens of other currently unsolved research challenges that could potentially benefit from the application of already existing specific video game algorithms. FIG. 24 illustrates the way that the IA mixed-structure system 90 disclosed is able to keep the general-purpose AI aligned with the specific context of the problem, to great effect. FIG. 26 shows that the same mixed-structure IA system 90 can be used, with no modification, to explore a complex problem in the humanities.

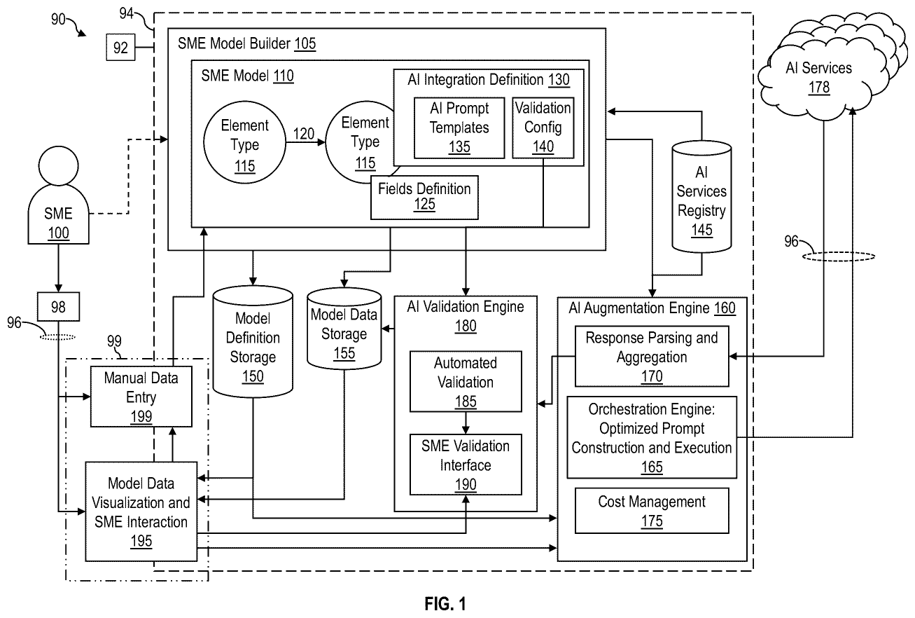

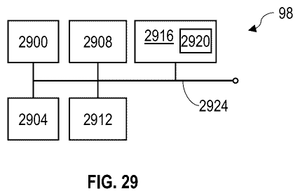

Referring now to the drawings, shown in FIG. 1 is a block diagram of an exemplary embodiment of an IA mixed-structure system 90 constructed in accordance with the present disclosure. Generally, the IA mixed-structure system 90 comprises a processing component 92 and a memory 94 comprising a non-transitory processor-readable medium storing processor-executable instructions that when executed by the processing component 92 causes the processing component 92 to perform one or more function. Use of the IA mixed-structure system 90 may begin with a subject matter expert 100 (SME 100) interacting with one or more user device 98 (shown in FIG. 29 and discussed in more detail below) operable to receive one or more input from the SME 100 and provide the one or more input to the processing component 92 executing an SME model builder 105. Generally, the SME 100 may interact with the SME Model Builder 105 to create an SME model 110 (e.g., a domain model) composed of one or more model element types 115 that are connected together via one or more connection types 120. Model element types 115 and connection types 120 may both be considered model components of the SME model 110 and may have metadata, such as properties, associated therewith. The SME Model Builder 105 may be software, such as one or more processor-executable instruction that when executed by one or more processing component 92, causes the processing component 92 to perform one or more action. The domain model may be, for example, a data structure of the SME model 110 as applied to a particular domain.

Exemplary embodiments of the processing component 92 may include, but are not limited to, a digital signal processor (DSP), a central processing unit (CPU), a field programmable gate array (FPGA), a microprocessor, a multi-core processor, an application specific integrated circuit (ASIC), combinations thereof, and/or the like, for example. The processing component 92 may be capable of communicating with the memory 94. The processing component 92 may be capable of communicating with one or more input device and/or one or more output device. The processing component 92 may include one or more processing component 92 working together, or independently, and located locally, or remotely, e.g., accessible via a network 96.

It is to be understood, that in certain embodiments using more than one processing component 92, the processing component 92 may be located remotely from one another, located in the same location, or comprising a unitary multi-core processor. The processing component 92 may be capable of reading and/or executing processor-executable code and/or capable of creating, manipulating, retrieving, altering, and/or storing data structures into the memory 94 such as in one or more database.

The processing component 92 may be further capable of interfacing and/or communicating with a user device 98 via the network 96 using a communication device. For example, the processing component 92 may be capable of communicating via the network 96 by exchanging signals (e.g., analog, digital, optical, and/or the like) via one or more port (e.g., physical ports or virtual ports) using a network protocol to provide updated information to the SME model builder 105.

The memory 94 may be one or more non-transitory processor-readable medium. The memory 94 may store the SME model builder 105 that, when executed by the processing component 92, causes the processing component 92 to perform an action such as communicate with or control one or more component of the IA mixed-structure system 90 and/or, via the network 96, AI services 178. The memory 94 may be one or more memory 94 working together, or independently, to store processor-executable code and may be located locally or remotely, e.g., accessible via the network 96.

In some embodiments, the memory 94 may be located in the same physical location as the processing component 92, and/or one or more memory 94 may be located remotely from the processing component 92. For example, the memory 94 may be located remotely from the processing component 92 and communicate with the processing component 92 via the network 96. Additionally, when more than one memory 94 is used, a first memory 94 may be located in the same physical location as the processing component 92, and additional memory 94 may be located in a location physically remote from the processing component 92. Additionally, the memory 94 may be implemented as a “cloud” non-transitory processor-readable medium (i.e., one or more memory 94 may be partially or completely based on or accessed using the network 96).

The network 96 may be almost any type of network. For example, in some embodiments, the network 96 may be a version of an Internet network (e.g., exist in a TCP/IP-based network). In one embodiment, the network 96 is the Internet. It should be noted, however, that the network 96 may be implemented as the World Wide Web (or Internet), a local area network (LAN), a wide area network (WAN), an LPWAN, a LoRaWAN, a metropolitan network, a wireless network, a WiFi network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, a short-wave wireless network, a long-wave wireless network, combinations thereof, and/or the like. It is conceivable that in the near future, embodiments of the present disclosure may use more advanced networking topologies.

The network 96 may permit bi-directional communication of information and/or data between the IA mixed-structure system 90 and/or AI services 178. The network 96 may interface with the IA mixed-structure system 90 and/or the user device 98 in a variety of ways. For example, in some embodiments, the network 96 may interface by optical and/or electronic interfaces, and/or may use a plurality of network topographies and/or protocols including, but not limited to, Ethernet, TCP/IP, circuit switched path, combinations thereof, and/or the like, as described above.

In one embodiment, each component of the SME model 110 may be configured to store one or more user-defined fields 125 (hereinafter field definitions 125) and one or more user-defined AI integration definitions 130 (hereinafter AI integration definitions 130) which contain at least an AI prompt template 135, used to send prompts to one or more artificial intelligence services 178 (hereinafter “AI service 178”, discussed below in more detail), and (optionally) one or more validation configuration parameters 140 indicative of a response validation returned by the AI services 178. Each prompt sent to the one or more AI services 178 may be a user input, or instruction, provided to the one or more AI services 178 that the one or more AI service 178 is to act upon, e.g., as a basis for a service response from the one or more AI services 178.

In one embodiment, the AI integration definitions 130 may further include one or more prompt settings associated with at least one service response from the one or more AI services 178. The one or more prompt settings may include at least a response format, a response validation, and a response storage. The response storage may be, for example, an indication of where, in the SME model 110, to store the service results from the AI service 178. For example, the response storage may indicate that the service response should update a particular component type such as by storing the service response in one or more field definitions 124, or may indicate that the service response should create new model components of the SME model 110, or both.

The ability to validate AI responses, if desired, is an important component (as discussed below in relation to AI validation engine 180) because, traditionally, responses from AI services are prone to “hallucination,” that is, making up, or fabricating, responses that are grammatically correct but are factually false.

When validation involves the SME model 110, the validation forms a part of allowing the IA mixed-structure system 90 to function as a “human-in-the-loop” system. When validation involves an algorithmic service, the automated algorithmic validation allows for increased scalability of the IA mixed-structure system 90 once the SME 100 is confident in the accuracy of the validation algorithm.

In one embodiment, the SME model builder 105 allows the SME 100 a large degree of expressiveness about the phenomena or problems the SME 100 is trying to model with the SME model 110. Therefore, in one embodiment, a property-graph-based representation is utilized in which the SME model 110 is represented as a network of nodes (model element types 115) connected by edges (connection types 120), thereby enabling the SME 100 the ability to represent almost any phenomena or problem of interest, simple or complex, while also being structured enough to allow well-defined integrations with algorithmic systems. However, one could imagine other embodiments of the present disclosure that could utilize other representations of the SME model 110, such as in a more traditional relational database table-based representation or in a more abstract network representation, such as text-based RDF triples.

In one embodiment, the SME model 110 may have a model definition that may be stored in the memory 94, such as in a model definition storage 150. The model definition is data describing the model element types and connection types, and may be, for example, a data structure of the SME model 110 in a data format, such as JSON, YAML, XML, and/or the like. Since the SME model 110 will be used to store data and structure data that is associated with the SME model 110, these data may also be stored in the memory 94, such as in a model data storage 155. The SME model 110 and the model data is made available for the SME 100 to visualize and interact with via an SME interaction and data view component 195 provided by the processing component 92. The SME interaction and data view component 195 may be processor-executable code that when executed by the processing component 92 may cause the processing component 92 to provide a primary user interface 99 to the user device 98 of the SME 100. The primary user interface 99 of the user device 98 may further include one or more manual entry component 199, provided by the processing component 92, and operable to receive one or more input from the SME 100 indicative of model data to be included in the SME model 110. In one embodiment, the SME 100 can interact with the primary user interface 99 without engaging AI augmentation by interacting with the SME model builder 105, the one or more manual entry component 199, and/or the SME interaction and data view component 195.

In one embodiment, the model definition storage 150 and/or the model data storage 155 may be one or more databases and may be, for example, a time-series database, a relational database, a vector database, or a non-relational database. Examples of such databases include DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, Chroma, Pinecone, Weaviate, and/or the like. It should be understood that these examples have been provided for the purposes of illustration only and should not be construed as limiting the presently disclosed inventive concepts. The model definition storage 150 and/or the model data storage 155 may be centralized or distributed across multiple systems.

When the SME 100 desires to use AI to augment their understanding, the SME 100 can issue a command through (e.g., provide an input to) the primary user interface 99 of the user device 98, thereby causing the processing component 92 of the IA mixed-structure system 90 to execute an AI Augmentation Engine 160. The AI augmentation engine 160 may include software operable to perform three high-level functions: an orchestration engine 165 operable to orchestrate AI service calls (e.g., RESTful, SOAP, RPC, etc.) to the one or more AI services 178; a response parsing function 170 operable to parse one or more service response from the AI services 178 and aggregating the one or more service response, as needed, to obtain a structured format (e.g., conforming to the model definition stored in the model definition storage 150) for insertion back into the SME model 110; and (optionally) a cost management function 175 operable to keep track of one or more costs (monetary or other form of cost, such as, compute time) incurred by the orchestrated service calls.

In one embodiment, the IA mixed-structure system 90 may further include an AI services registry 145 operable to store a communication interface for each of the one or more AI service 178. Because the IA mixed-structure system 90 may not know which AI services might be of most use to a particular problem or phenomenon investigated by the SME 100 using a particular SME model 110, and because new AI services 178 may be developed by third-parties for which the SME 100 may desire to leverage to augment their understanding of the particular phenomena or problem, the AI services registry 145 allows the IA mixed-structure system 90 to store a communication interface for a new AI service included with the one or more AI services 178, thereby expanding the number of AI services 178 the IA mixed-structure system 90 can communicate with.

In one embodiment, the processing component 92 may receive results from the AI augmentation engine 160 and pass the received results to an AI validation engine 180. The AI validation engine 180 may include software such as one or more processor-executable instructions such as an automated validation subsystem 185 and an SME validation interface 190. The automated validation subsystem 185 may include instructions that when executed by the processing component 92 may cause the processing component 92 to automatically validate the received responses and pass the validated received responses to the model data storage 155. The SME validation interface 190 may include instructions that when executed by the processing component 92 may cause the processing component 92 to provide the SME validation interface 190 on the primary user interface 99 via the SME interaction and data view component 195, thereby enabling the SME 100 to review the received results, (optionally) modify the received results, and provide an indication of automated validation status: either an acceptance (validation), or a rejection, of the received results after being processed by the automated validation subsystem 185.

Because intelligence augmentation, especially with regard to exploration of complex phenomena, works best when the intelligence augmentation is an iterative process, the processing component 92 may store the accepted/validated results in the model data storage 155. Once the accepted/validated results are stored in the model data storage 155, the SME model 110 may be updated to further include the accepted results when the SME model 110 is displayed, or visualized, in the primary user interface 99 within which the SME 100 is interacting with the SME model 110 having the model data. The arrows between the SME interaction and data view component 195, the AI augmentation engine 160, and the AI validation engine 180 are shown to indicate communication between the components thereby enabling the SME 100 to iterate through changes to the SME model 110 without having to shift between interfaces.

In other words, using the visualization in the primary user interface 99 of the SME model 110 having the model data to choose where to augment, which results to validate, and viewing how those validated results change the model data in the SME model 110 in order to repeat the augmentation, either with manually added model data via the manual entry component 199 (e.g., that the SME 100 now realizes may be relevant) or with additional automated augmentation via the AI augmentation engine 160 improves functioning of the computer system by eliminating excess computations of the processing component 92 that would otherwise result from the SME 100 frequently switching between interfaces or windows within the user device 98 or the primary user interface 99.

Moreover, the IA mixed-structure system 90 disclosed herein provides a technological solution to the technological problem of managing the highly iterative process of investigating complex problems and interacting with AI services 178. New model data as a result of the AI augmentation may cause the SME 100 to reconsider the way they are modeling their problem of interest, leading to them making changes to the SME model 110. New, updated, or breaking changes to the AI services 178 may cause the SME 100 to reconsider the prompts they are providing to the AI services 178, choose different areas of the SME model 110 to augment, or change their SME model 110 as a result of new AI service capabilities. These types of changes would traditionally require the SME 100 to rebuild an entire workflow to accommodate the changes to the AI services 178, or their new perspective on the problem model, into a domain-specific implementation, but by providing the domain-agnostic SME model builder 105, the AI services registry 145, the AI augmentation engine 160, the AI validation engine 180, and the primary user interface 99 (and associated processes disclosed herein) it is possible to manage the iterative process of interacting with an evolving understanding of the problem under investigation and the AI services 178 being used to augment that investigation without having to rebuild an entire workflow.

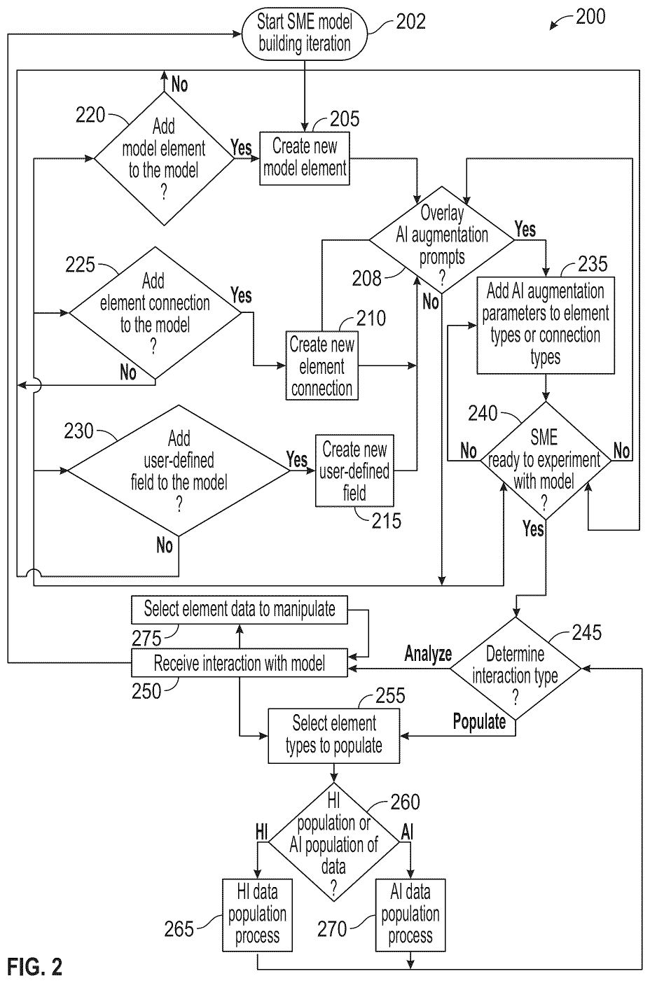

Referring now to FIG. 2, shown therein is a flowchart of an exemplary embodiment of a user workflow 200 constructed in accordance with the present disclosure. The user workflow 200 may show, for example, an iterative use of the IA mixed-structure system 90 by the SME 100. The user workflow 200 may be utilized to build an SME model 110 (shown in FIG. 1, above). In one embodiment, the user workflow 200 begins with building the model definition of the SME model 110 (step 202). It should be noted that, as the SME 100 uses the IA mixed-structure system 90, the model definition may be updated, edited, or otherwise changed. The user workflow 200 starts at start step 202 and continues to a creating a model element type (step 205).

In one embodiment, the model element type 115 may refer to a type of a situation, problem, or thing that the SME 100 is interested in with regards to one or more complex phenomena. For example, if the SME 100 is working on a problem (e.g., complex phenomena) related to teams of people that work on different projects (a “teams of people” problem), a first model element type 115 may have an element type of “team”, e.g., be a first element type or a “team” element type, a second model element type 115 may have an element type of “person”, e.g., be a second element type or a “person” element type, and a third model element type 115 may have an element type of “project”, e.g., be a third element type or a “project” element type. Once the SME 100 has created at least one model element type, the user workflow 200 continues with determining whether to overlay AI augmentation prompts (decision 208).

Upon determination not to overlay AI augmentation prompt at decision 208, the user workflow 200 continues to determining if one or more model element types 115 should be added to the model definition (decision 220), which would return to creating a model element type (step 205); determining if one or more connection types should be added to connect at least two model element types 115 of the model definition (decision 225), which would lead to creating a connection type between at least two model element types 115 (step 210); and determining if one or more data fields should be added to one or more of: the one or more model element types 115 or one or more connection types 120 (decision 230), which leads to adding one or more field definitions 125 to one or more of the one or more model element types 115 and/or one or more connection types 120 (step 215), before returning again to decision 208. In one embodiment, upon determination not to overlay AI augmentation at decision 208 and not to add to the model definition in decisions 220, 225, and 230, the user workflow 200 continues to decision 240.

In one embodiment, the one or more connection types 120 may be a connection between two or more model element types, such as a relationship between each of the two or more model element types. For example, a first connection type 120 may indicate a relationship of “member” (e.g., be a first connection type, or a “member” connection type) of the second element type (the “person” element type) in the first element type (the “team” element type), a second connection type 120 may indicate a relationship of “work” (e.g., be a second connection type, or a “work” connection type) between the second element type and the third element type indicating that the “person” element type works on the “project” element type. In this way, the connection types between the one or more model element types and the one or more connection types may be stored in the model definition, that is, the model definition may include all of the model components of the SME model 110. In one embodiment, deciding to add one or more data field (decision 230) may include adding one or more field definitions 125 to the model definition of the SME model 110. The one or more field definitions 125 may be (for example) a structured format configured to receive model data indicative of specific instances of any component type in the model definition.

Upon determination to overlay AI augmentation prompts at decision 208, the user workflow 200 continues to adding AI integration definitions 130 to one or more of the model element types 115 and/or the connection types 120 (step 235). In one embodiment, step 235 may be repeated for one or more iteration. In one embodiment, the AI augmentation prompt may be associated with a first AI service 178.

In one embodiment, after adding AI integration definitions (step 235) the user workflow 200 may return to decision 208 to determine whether to overlay a second AI augmentation prompt. In one embodiment, the second AI augmentation prompt may be an AI augmentation prompt associated with a second AI service 178.

In one embodiment, upon determining to experiment with the SME model 110 having the model definition at decision 240, the user workflow 200 continues to determining a mode of interaction (decision 245). The mode of interaction may be, for example, an analyzing mode or a populating mode. Upon determination to interact with the model data via an analyzing mode at decision 245, the user workflow 200 continues to causing the processing component 92 to provide an interactive view of the SME model 110 and associated model data stored in model data storage 155 on the primary user interface 99 (e.g., as part of receiving an interaction with the SME model in step 250, described below). At this point, the processing component 92 may receive one or more input from the user device 98 indicative of a selection of one or more model elements or one or more model connections and of a data manipulation of model data associated with the selection (step 275).

Upon determination to interact with the model data via a populating mode at decision 245, the user workflow 200 continues to receiving a selection of a component of the one or more model components to populate (step 255). The one or more components of the one or more model components may include, for example, an element type of the one or more model element types 115 and/or a connection type of the one or more model connection types 120. Upon receiving the component selection, the processing component 92 may determine whether to populate model data with Human Intelligence (HI) or Artificial Intelligence (AI), for example, based on whether the AI integration definition 130 has been created, that is, if the AI integration definition 130 is created, the processing component 92 may determine to populate the model data of the selected component via an AI data population process 270 otherwise, the processing component 92 may determine to populate the model data of the selected component via an HI data population process 265. After data population, either through the AI data population process 265 or the AI data population process 270, the user workflow 200 may return to decision 245.

In one embodiment, when the SME 100 is populating data, the SME 100 selects a one or more model elements and/or model connections of the one or more model elements and model connections present within the model data to populate (step 255), though, in other embodiments, the SME 100 may select one or more model element types and/or model connection types of the one or more model components in the model definition. In one embodiment, the processing component 92 may receive one or more input from the SME 100 via the user device 98 indicative of an interaction with the SME model 110 (step 250), which may include interactions such as manipulation of the model data (e.g., as a whole or for a particular model component or data instance of a model component) in the SME model 110, such as editing of the model data, deletion of the model data, and/or the like. This capability ensures that the SME 100 has availability of the full range of “CRUD” database operations (Create, Read, Update, Delete) and can therefore utilize the SME model 110 created by the IA mixed-structure system 90 as a domain-specific database. Unlike traditional CRUD databases, where the CRUD operations are performed in response to user or API input, the processing component 92 of the IA mixed- structure system 90 can populate the SME model 110 with model data via AI augmentation. When the SME 100 decides to use AI population instead of HI population (step 260), the AI data population process 270 relies on the AI integration definitions 130) that the SME 100 added to model components, for example at step 235.

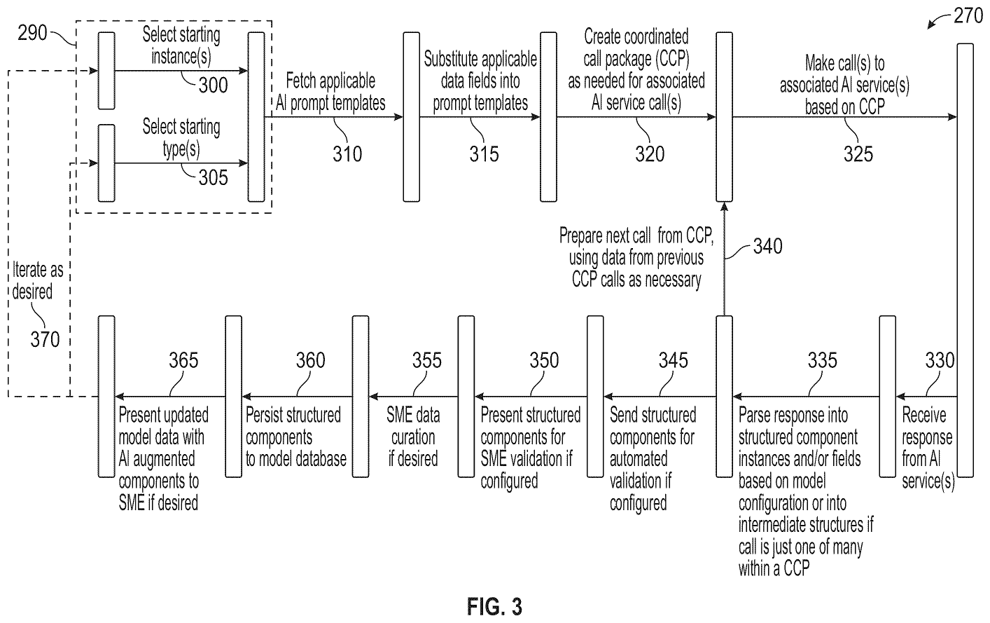

Referring now to FIG. 3, shown therein is a sequence diagram of an exemplary embodiment of the AI data population process 270 constructed in accordance with the present disclosure. The AI data population process 270 may be iterative in nature and may be started by the SME 100 as desired. For example, the SME 100 may cause the user device 98 to send one or more command to the processing component 92 of the IA mixed-structure system 90 to cause the processing component 92 to initialize the AI data population process 270. In this way, as the SME 100 desires to change and update the SME model 110 (e.g., a first domain model instance) based on the model data provided through the AI data population process 270, the AI data population process 270 can be reinitialized to populate model data for the updated or changed model (e.g., for a second domain model instance).

In one embodiment, the AI data population process 270 starts with determining the augmentation entry point (step 290). Determining the augmentation entry point (step 290) may include, for example, the processing component 92 determining whether the SME 100 has selected an instance of one of: the model element or the model connection (step 300) or selected one of: the model element type or the model connection type (step 305). Once the augmentation entry point is selected, the processing component 92 executing the AI augmentation engine 160 will begin the AI data population process 270.

In one embodiment, the processing component 92 may fetch one or more AI prompt templates 135 from the memory 94 (step 310) based on the augmentation entry point determined. The processing component 92 may look up associated AI integration definitions 130 for the augmentation entry point (e.g., a particular element type or connection type) and select the one or more AI prompt templates 135 based on the associated AI integration definitions 130 for that particular element type or connection type. In one embodiment, each of the AI prompt templates 135 includes at least one prompt template having one or more placeholders (discussed below in more detail).

In one embodiment, the particular element type or connection type may have a prompt template with zero placeholders, thereby enabling the processing component 92 to proceed from step 310 to step 320 (and consider the prompt template as a “dynamic prompt” for execution of the steps 320 and 325. In one embodiment, if the particular element type or connection type selected as the augmentation entry point does not include model data (e.g., is unpopulated) and the AI integration definition 130 includes one or more placeholders, then the processing component 92 may cause one or more notifications to be displayed indicative of a lack of model data preventing the processing component 92 from continuing on to step 315, and the processing component 92 may further return to step 290 to determine a second (new) augmentation entry point.

In one embodiment, the processing component 92 may substitute one or more data fields from the model data into the one or more AI prompt templates (step 315). For example, the at least one prompt template may be a text template wherein one or more data fields of the model data of an instance of that particular element type or connection type may be inserted (e.g., as a placeholder value) into the one or more placeholders to form a “dynamic prompt.” The data field and/or the text template may be a prompt or portion of a prompt and may be based in part on current vernacular found to be affecting output from an unstructured generative AI, e.g., the service response from the AI service 178. In one embodiment, the at least one prompt template may include one or more of a text template, an audio template, a video template, and an image template, or a combination thereof. For example, in one embodiment, the at least one prompt template may have an image placeholder (operable to be replaced with an image or a link to an image) and a text template. In one embodiment, the placeholder may be replaced with one or more of a dynamically computed variable and a static value. For example, if the placeholder is [current month], the placeholder value may be dynamically computed to be the month in which the dynamic prompt is created.

For example, referring again to the “teams of people” problem discussed above, a first prompt template on the third element type (the “project” element type) might include a template string such as, “What projects are being worked on by [team]?” Where [team] is a placeholder into which the processing component 92 may substitute model data associated with the particular instances of the first element type (the “team” element type) retrieved from the model data storage 155. In this way an unpopulated model (e.g., a model having the model definition but no model data) can be thought of as a domain-specific database related to the problem domain the SME 100 is interested in (e.g., team/project dynamics) and a populated model (e.g., a model having the model data, or a [domain] model instance) can be thought of as representing the domain-specific database holding model data as a result of applying the SME's domain-specific model to a corpus of knowledge that may be provided by the HI data population process 265 and/or the AI data population process 270.

Further, in one embodiment, if the SME 100 uses manual data population (i.e., step 265, FIG. 2) to add two specific “team” element type instances, then the AI prompt template 135 may resolve to two dynamic prompts based on each of the specific “team” element type instances. For example, if the two specific “team” element type instances include “GE's Energy Division” and “GE's Aeronautical Division”, then the AI prompt template 135 “What projects are being worked on by [team]?” may resolve to two dynamic prompts of “What projects are being worked on by GE's Energy Division?” and “What projects are being worked on by GE's Aeronautical Division?” if the augmentation entry point is selected at the third element type (e.g., the “project” element type). If the augmentation entry point is a specific selected instance of an element type instead of the general element type itself, then the AI prompt template 135 would result in a single dynamic prompt based on the model data of the augmentation entry point (e.g., based on the model data already associated with the selected element type instance).

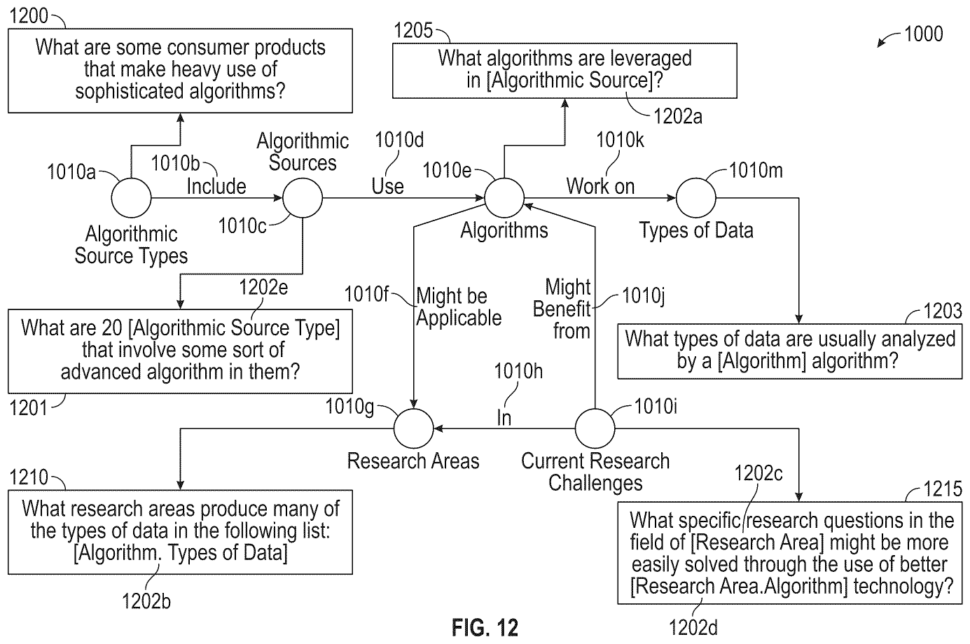

It should be understood that dynamic prompts based on the one or more AI prompt templates 135 are not limited to being constructed based on a name (or other identifier, such as a primary key unique identifier) of a selected model component instance (e.g., of selected element type instances or selected connection type instances). In one embodiment, the processing component 92 may substitute one or more data field (e.g., data defined in the user-defined fields 125) into the one or more AI prompt templates (step 315). For example, a dynamic prompt may be constructed based on one or more data fields associated with the component type definitions (as discussed in more detail below and shown in FIG. 12).

In this way, the creation of dynamic prompts based on one or more AI prompt templates 135 (e.g., model-aware prompt templates) allows the IA mixed-structure system 90 to be integrated with a plurality of the AI services 178, such as with public, general, AI services 178 (including ChatGPT, OpenAI, Inc., San Francisco, California) but also with one or more local Ais and/or one or more fine-tuned Ais that have been trained for specific use cases. While services like ChatGPT might be able to form a reasonable response to the question of projects worked on by GE teams-that is only because GE is a large company with a lot of information about the work of different divisions available on the Internet that has been used to teach the ChatGPT model. In one embodiment, the IA mixed-structure system 90 may be configured (e.g., by including a new AI integration definition 130 in the AI services registry 145) to use a local AI implementation (e.g., a local AI service 178) that has been trained, fine-tuned, or refined (e.g., via low-rank adaptation) with non-public information about teams and projects, or to query both.

In one embodiment, the SME 100 may interact with the user device 98 to cause the processing component 92 to update, edit, or modify a particular prompt template of the one or more AI prompt templates 135 based on a particular AI services 178 to which the particular prompt template is directed/associated in order to optimize service results returned by the particular AI services 178.

In one embodiment, after the AI prompt templates are used to generate the dynamic prompts, the processing component 92 of the IA mixed-structure system 90 transforms the dynamic prompts into a coordinated call package (step 320). The coordinated call package (CCP) may include, for example, one or more optimized prompts and one or more AI service calls. Generally, each AI service 178 may have limitations in how the particular AI service 178 is called and may require one or more specific instructions to be embedded within the dynamic prompts sent to the particular AI service 178 in order to receive service results that are accurate or to receive service results in a desired format or having a desired data-structure.

For example, if an AI prompt template is “Summarize the following: [book.content] in one paragraph” and is linked to a domain model containing model elements having a book element type with a content field (e.g., data field) holding the entire text of the book, it is unlikely that the resulting dynamic prompt (from step 315) can be sent to the AI service 178 without modifications due to the length of the resulting dynamic prompt (e.g., the length of the resulting dynamic prompt may exceed the AI service's API maximum payload size for, or other requirements of, the AI service 178). In order to overcome these technological limitations, the coordinated call package (CCP) provides that the processing component 92 may generate an optimized data payload, for example, by executing a “summary of summaries” summarization process such as by segmenting the content field having a text that would exceed the API maximum payload size of the AI service 178 into a plurality of text chunks and may send one or more summary requests (e.g., AI service call) to the AI service 178 requesting that the AI service 178 summarize the text chunk. The processing component 92 may subsequently receive the service responses having a text chunk summary corresponding to the text chunk of each AI service call (e.g., as a first service response and a second service response) and assemble (by using parsing and aggregating settings of the response parsing function 170 of the AI augmentation engine 160 (or otherwise stored in the memory 94 or the AI services registry 145) the text chunk summaries as an input to the placeholder (e.g., [book.content] of the above example) of the AI prompt template. In one embodiment, if the assembled text chunk summaries still exceed the context window, may repeat the summarization process. In this way, the CCP provides the appearance of being a singular API call from the perspective of the SME 100, but, instead, is multiple, coordinated AI service calls.

Generally, the service results received from the one or more AI service 178 may include unstructured text, or text that is in paragraph, human-readable form. In one embodiment, the processing component 92 of the IA mixed-structure system 90 may further transform (e.g., parse and assemble) the unstructured text otherwise returned by the AI services 178 into a structured format aligned with the defined fields of the model definition using the response parsing function 170 of the AI augmentation engine 160. Here, the CCPs also enable the processing component 92 to embed one or more response format into the one or more optimized prompts, thereby “teaching” (or “instructing”, such as with few-shot learning) the AI service 178 to transform the unstructured text that would otherwise be returned into a service result having the one or more response format. In some embodiments, the CCP may further include instructions to cause the processing component 92 of the IA mixed-structure system 90 to make one or more configuration API call to the AI service 178 thereby affecting the one or more response format for the service results returned.

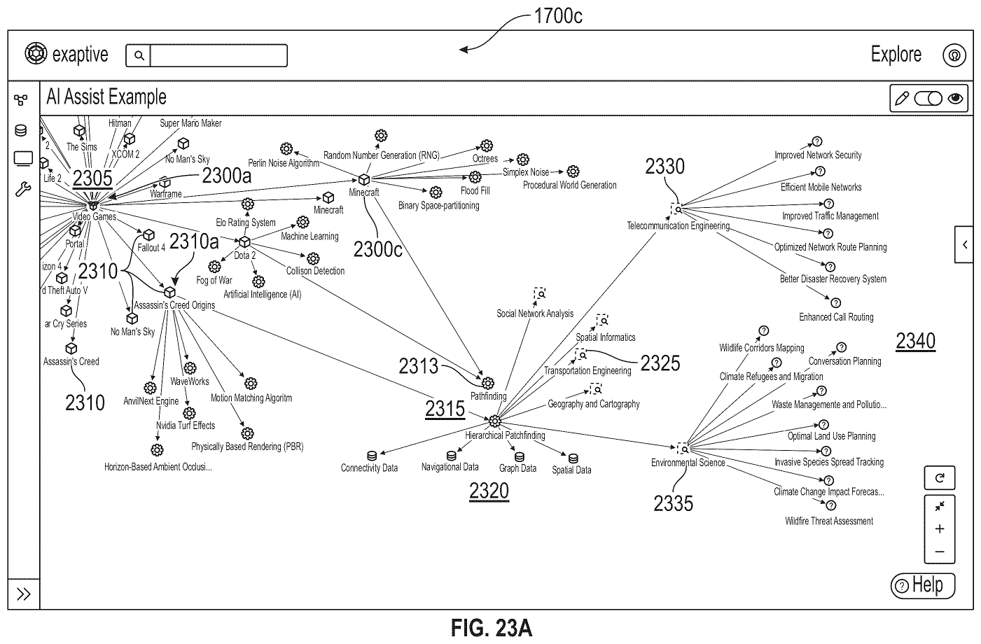

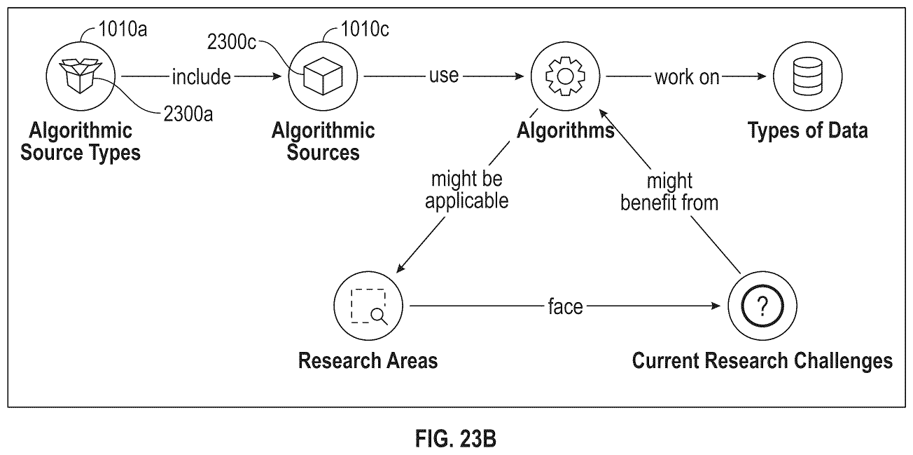

In one embodiment, when more than one augmentation entry point is selected by the SME 100, the processing component 92 may fetch one or more AI prompt template 135 from the memory 94 for each augmentation entry point (step 310). At step 315, the processing component 92 may examine model data available for each of the selected augmentation data point and, based on a relationship hierarchy of the selected augmentation data points in the SME model 110, the processing component 92 may determine an augmentation priority for each of the selected augmentation entry points, e.g., may determine an augmentation path, discussed below in reference to FIG. 23. Referring back to the GE example above, if a first selected augmentation entry point (e.g., a model element type of “team”) is connected to a second selected augmentation entry point (e.g., an element instance of an element type of “organization” having a model data of “GE”) by an element type having a connection type of “is a department of”, the processing component 92 may determine that the second selected augmentation entry point has a higher priority than the first selected augmentation entry point, for example, because, the second selected augmentation entry point is an element instance having model data that, after AI augmentation, may provide a list of departments that the processing component 92 may supply as model data to the model element having the element type of “team” of the first selected augmentation entry point and which model data may be necessary to create the AI prompt template 135 as discussed above.

In one embodiment, once the CCP has been created (step 320), the AI service calls are sent to the AI services (step 325). The processing component 92 may transmit the AI service calls to the AI services 178 via the network 96 utilizing one or more protocol, such as a REST, SOAP, or RPC protocol. Further, the processing component 92 may transmit the AI service calls to the AI services 178 either serially or in parallel (e.g., either synchronously or asynchronously). In one embodiment, the processing component 92 may transmit the AI service calls of a first CCP corresponding to a first dynamic prompt and the AI service calls of a second CCP corresponding to a second dynamic prompt to the AI service 178 either serially or in parallel. Further, the processing component 92 may transmit the AI service calls of a first CCP corresponding to a first dynamic prompt to a first AI service 178 and the AI service calls of a second CCP corresponding to a second dynamic prompt to a second AI service 178 either serially or in parallel.

In one embodiment, the orchestration engine 165 may include processor-executable instructions that cause the processing component 92 to perform step 310, step 315, step 320, and step 325 of the AI data population process 270.

When a service response is received for a specific AI service call (step 330) the processing component 92 of the IA mixed-structure system 90 (executing, for example, the response parsing function 170) parses the service response into a structured response having the structured format (step 335). In one embodiment, the structured response having the structured format may comply with the model definition, such as the model definition stored in the model definition storage 150. In other embodiments, such as when the CCP includes multiple AI service calls to the AI services 178, the structured responses may include data from a first service response for a first service call of the multiple AI service calls and be updated to include data from a second service response of a second service call of the multiple AI service calls, for example to assemble text chunks as described above (step 340).

In one embodiment, the processing component 92 of the IA mixed-structure system 90 may insert the structured response into one or more data field of a model component of the SME model 110 (or into a model component instance already having model data by replacing model data with data from the structured response or by including additional data that was not already present in the model data). In one embodiment, the processing component 92 of the IA mixed-structure system 90 may further store the structured response having the structured format in the memory 94.

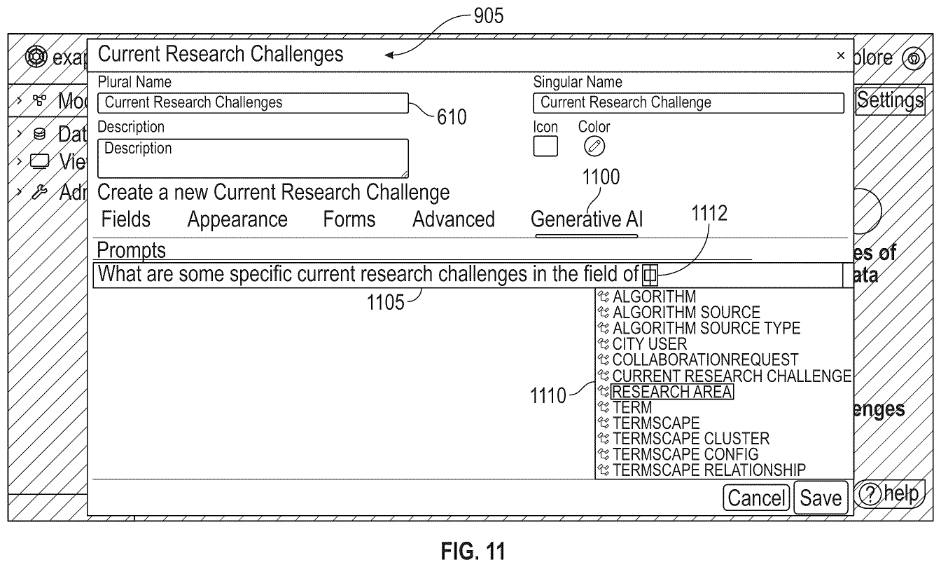

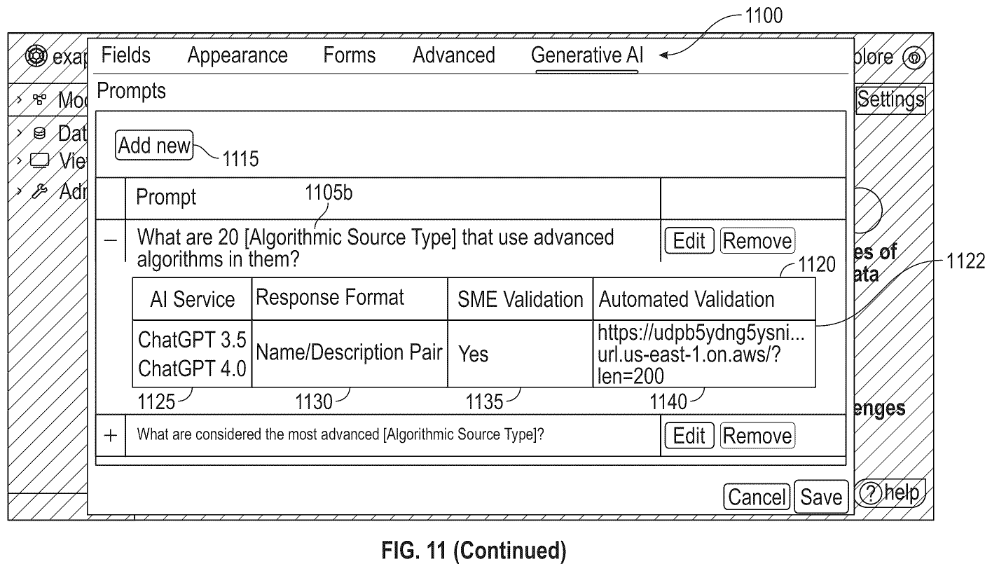

In one embodiment, the structured response is (optionally) validated by the processing component 92 of the IA mixed-structure system 90 executing the AI validation engine 180 (step 345). For example, if the SME 100 has provided the one or more validation configuration parameters 140 with an automated validation endpoint 1122 (described below and shown in FIG. 11), the processing component 92 of the IA mixed-structure system 90 executing the automated validation subsystem 185 may provide the structured response to the automated validation endpoint 1122. The processing component 92 may then receive an autovalidated response from the automated validation endpoint 1122. The autovalidated response may be, for example, a modified structure response such as by removing, or flagging, data in the structured response that fails to pass a particular validation test.

In one embodiment, the processing component 92 may remove or flag research articles (returned in the structured response) if the research articles are not found in the PubMed (United States National Library of Medicine) database based on a response from a (non-AI) PubMed API to perform a title or PubMedID search. In other embodiments, the processing component 92 may adjust data in the structured response to a standardized format, for example, by sending company names to an automated validation endpoint 1122 (such as by using a Bloomberg (Bloomberg L. P., New York, New York) API) to convert the company names returned in the structured response into ticker symbols, and either remove or flag the model data in the structured response in instances where the adjustment is unable to be completed successfully.

In one embodiment, the processing component 92 of the IA mixed-structure system 90 executing the AI validation engine 180 may provide the autovalidated response (or the structured response) to the SME validation interface (step 350). In one embodiment, the SME 100 may select to have the autovalidated response proceed to be stored in the memory 94 (at step 260) without being provided to the SME validation interface 190. It should be noted that, in some embodiments, step 345 may be performed after step 350 and step 355. In one embodiment the SME validation interface 190 presents data from the autovalidated response to the SME 100 via the primary user interface 99 of the user device 98. In this way, the SME 100 may interact with the primary user interface 99 to cause the user device 98 (e.g., a processing component 2908 of the user device 98) to send one or more signals to the processing component 92 to cause the processing component 92 to remove or modify the data in the autovalidated response, as desired, to generate a fully-validated response in step 355.

In one embodiment, the fully-validated response may be stored in the memory (step 360). For example, the processing component 92 of the IA mixed-structure system 90 may store the fully-validated response (still having the structured format) in the memory 94 such as in the model data storage 155. In one embodiment, storing the fully-validated response in the memory 94 may further include combining the fully-validated response with model data of the SME model 110, that is, updating the model data of the SME model 110 to include the fully-validated response. For example, the processing component 92 may generate new instances for one or more model component based on the structured format of the fully-validated response.

In one embodiment, the processing component 92 of the IA mixed-structure system 90 executing the SME interaction and data view component 195 may modify a model view to include the updated model data.

In one embodiment, the processing component 92 of the IA mixed-structure system 90 executing the SME interaction and data view component 195 may cause the primary user interface 99 to display the SME model 110 with the updated model data (step 365). In this way, the SME 100 may visualize and/or analyze the model data for the SME model 110 as augmented by the AI services 178.

In one embodiment, the AI data population process 270 may be repeated as desired by the SME 100 as indicated by arrows 370. Each time the AI data population process 270 is performed, a different augmentation entry point may be selected in step 290, or, in some embodiments, the same augmentation entry point may be selected in step 290, however, a different AI prompt template may be used in steps 310 and 315. For example, based on the SME's review of the SME model 110 in the primary user interface 99, additional iterations of the AI data population process 270 may per performed at new augmentation entry points (or, in some embodiments, the same augmentation entry points). In this way, each iteration may give the SME 100 feedback for changes or improvements that could be made to evolve the SME model 110, thereby leading to additional execution of the user workflow 200 prior to executing the AI data population process 270 again.

The user-defined model that is created as a result of the actions shown in FIG. 2 represent the SME's “idea for solving”. The “prompt templates” represent each of the SME's “question [s] asking for additional information”. The AI augmentation that is provided as a result of those questions, via the sequence diagram of FIG. 3, quickly assembles if not “exhaustive inventories”, exhaustive-enough inventories of items related to the idea for solving so that the SME 100 can then adjust the SME model 110 concomitant to filling the SME model 110 in with data by AI augmentation as described herein.

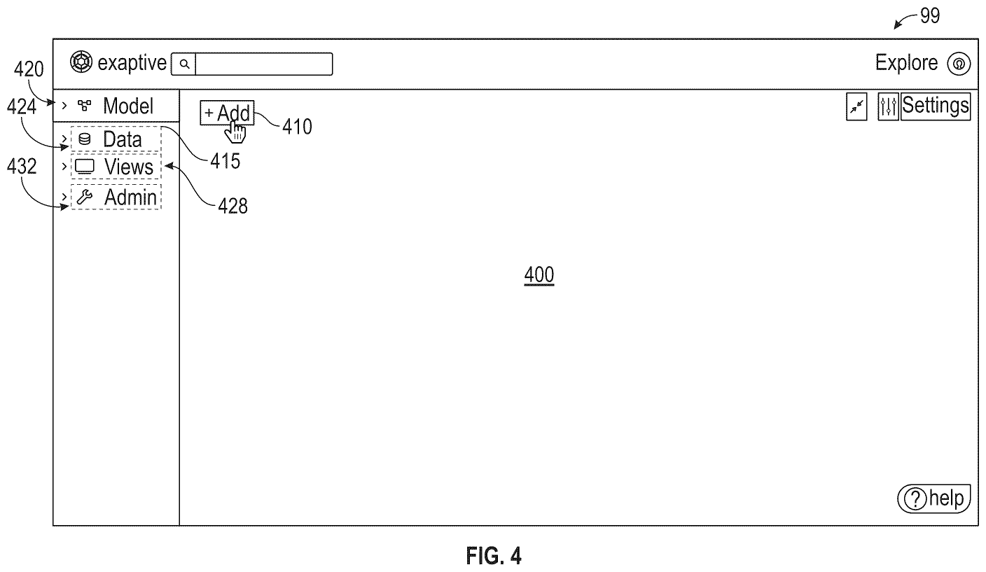

Referring now to FIG. 4, shown therein is a screenshot of an exemplary embodiment of a model builder and AI augmentation user interface 400 constructed in accordance with the present disclosure. The model builder and AI augmentation user interface 400 may be a particular embodiment of the primary user interface 99. In one embodiment, the SME 100 may begin the user workflow 200 (FIG. 2) via the model builder and AI augmentation user interface 400. The model builder and AI augmentation user interface 400 may include an add input 410 and a system menu 415 having a model menu item 420, a data menu item 424, a view menu item 428, and an admin menu item 432. It should be understood that more or fewer menu items may be included in the system menu 415. In one embodiment, the SME 100 begins the user workflow 200 by selecting the add input 410 to cause the processing component 92 to add a model component (such as a model element) to the SME model 110 (e.g., as described in step 205 above).

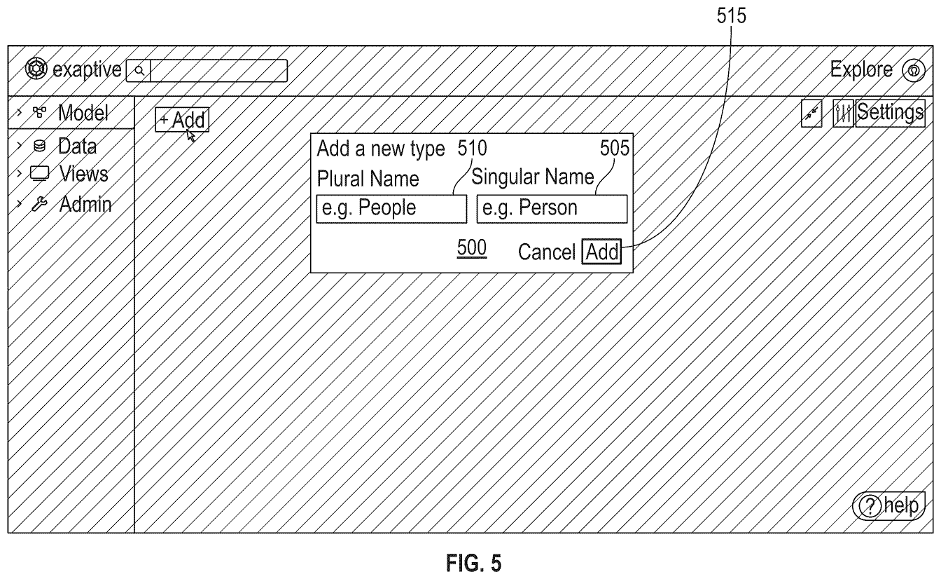

Referring now to FIG. 5, shown therein is a screenshot of an exemplary embodiment of a new element type modal window 500 of the model builder user interface of FIG. 4, constructed in accordance with the present disclosure. In one embodiment, upon selection of the add input 410 (FIG. 4), the processing component 92 causes the primary user interface 99 to display the new element type modal window 500 on the user device 98. In one embodiment, because the semantics of the prompt sent to the AI services 178 are important, the SME 100 is able to specify a singular form of the type for the model element type in a singular term input 505 and a plural form of the type for the model element type in a plural term input 510. The processing component 92 may perform different data substitutions when encountering the singular form or the plural form in prompt templates, e.g., in step 315. Upon selection of an add type input 515, the processing component 92 may create the element type as specified in the new element type modal window 500 and add the element type to the model definition of the SME model 110.

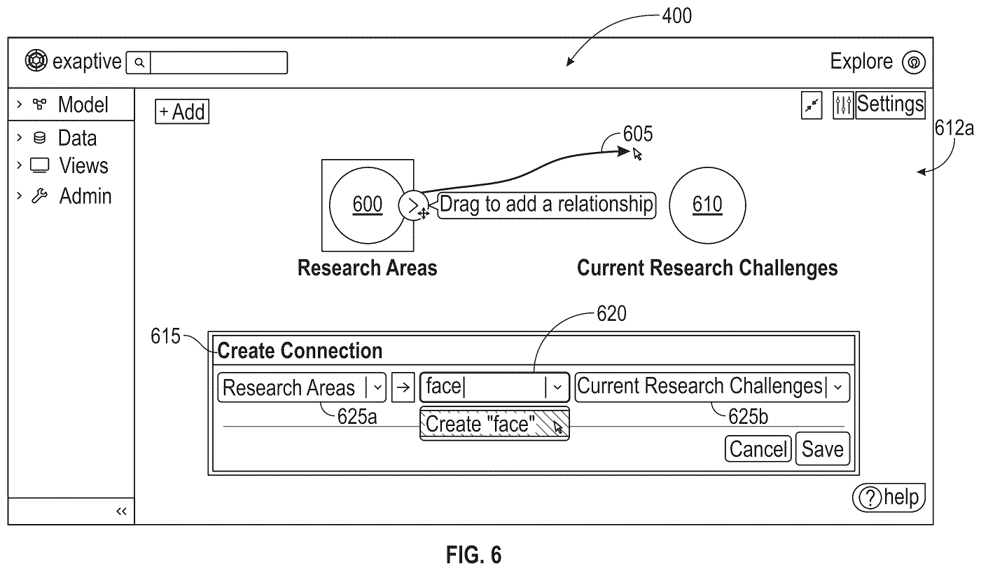

Referring now to FIG. 6, shown therein is the model builder and AI augmentation user interface 400 after two model elements have been added: a first model element type 600 having a “Research Areas” element type (e.g., a first element type) and a second model element type 610 having a “Current Research Challenges” element type (e.g., a second element type). The model builder and AI augmentation user interface 400 further shows the SME 100 adding a relationship (e.g., element connection) between the two model elements by dragging (with a cursor) from the first model element type 600 to the second model element type 610, which results in the processing component 92 causing an arrow to be formed between the first model element type 600 and the second model element type 610, thereby forming an SME model 612a and displaying the SME model 612a within the primary user interface 99. This relationship shown by the arrow is called a connection type 605.

In one embodiment, when the SME 100 connects the first model element type 600 and the second model element type 610 with the connection type 605, the processing component 92 causes the user device 98 to generate and display a new connection modal window 615. The new connection modal window 615 included a connection type relationship selector 620, thereby allowing the SME 100 to either assign a new name for the connection type 605, e.g., “face” connection type, or use a previously defined connection type (e.g., a connection type for the SME model 612a) for the relationship between the first model element type 600 having the first element type (selected in a first element selector 625a) and the second model element type 610 having the second element type (selected in a second element selector 625b).

In one embodiment, assignment of the new name results in a new connection type, while the selection of an existing connection type results in the drawn element connection representing another instance of the existing connection type. That is, the same connection type can be used to describe the relationship between more than one pair of model element types. For example, the first model element type 600 having the “Research Areas” element type, may be connected, through the connection type 605 with a “face” connection type, to the second model element type 610 having the “Current Research Challenges” element type, that is, Research Areas “face” Current Research Challenges. Similarly, Projects “face” Obstacles. The “face” connection type in both prior examples has a similar semantic relationship between two model element types.

In one embodiment, the semantics of the relationship (connection type) of an element type connection are only set for the plural semantics of the model element types and only for a particular direction of the relationship being drawn.

In some embodiments, the SME 100 may set the semantics of the relationship of the connection type of the element type connection for both singular forms and plural forms, e.g., ‘Research Areas “face” Current Research Challenges’ and ‘Research Area “faces” Current Research Challenge.’ Similarly, the SME 100 may set the semantics of the relationship to by a bidirectional relationship, e.g., ‘Current Research Challenges “exist within” Research Areas’ and ‘Current Research Challenge “exists within” Research Area.’ Defining these nuances of the semantics of a connection type 120 between model element types 115 allows the processing component 92 of the IA mixed-structure system 90 to make these semantics available to aid the SME 100 in the creation of AI prompt templates 135 that result in different dynamic prompts that can be better optimized by AI augmentation engine 160 during optimized prompt construction performed by the processing component 92 executing the orchestration engine 165.

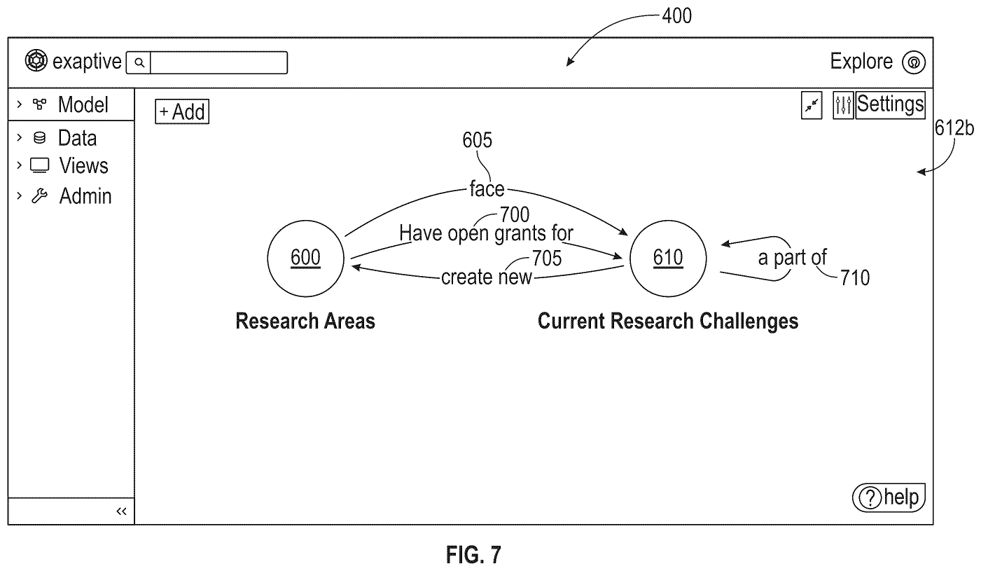

Referring now to FIG. 7, shown therein is a screenshot of another exemplary embodiment of the model builder and AI augmentation user interface 400 of FIG. 4 displaying an SME model 612b constructed in accordance with the present disclosure. The SME model 612b is constructed in accordance with the SME model 612a, with the exception that the SME model 612b further includes: a second connection type 700 of “have open grants for” extending from the first model element type 600 towards the second model element type 610 (e.g., Research Areas “have open grants for” Current Research Challenges); a third connection type 705 of “create new” extending from the second model element type 610 towards the first model element type 600 (e.g., Current Research Challenges “create new” Research Areas); and a third connection type 710 of “a part of” extending from the second model element type 610 and looping back towards the second model element type 610. In this way, the model builder and AI augmentation user interface 400 provides for an expressive capability to represent a set of complex relationships between model element types by allowing element types to have multiple connections of various connection types (relationships) in various directions.

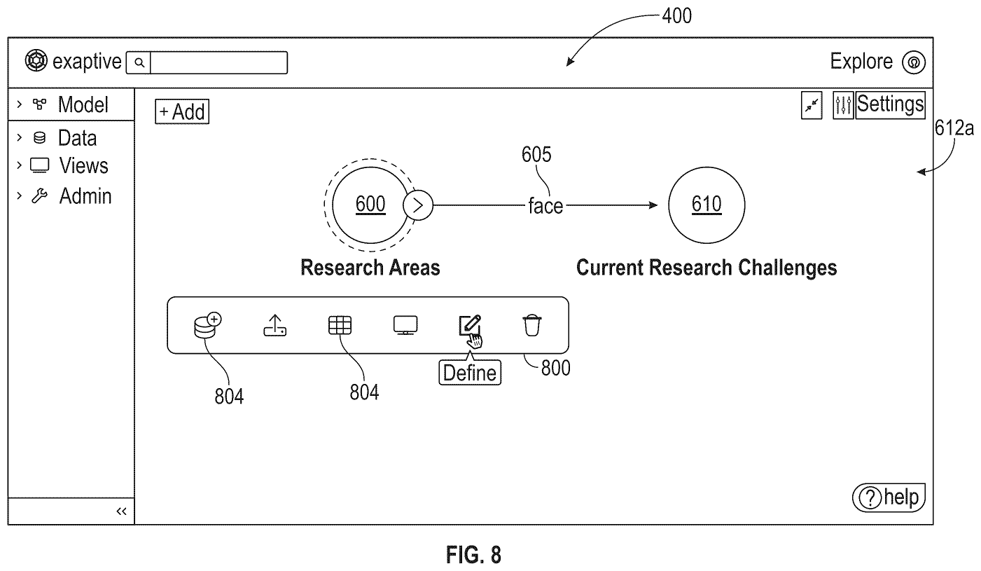

Referring now to FIG. 8, shown therein is a screenshot of another exemplary embodiment of the model builder and AI augmentation user interface 400 constructed in accordance with the present disclosure. The model builder and AI augmentation user interface 400 is further shown to include a popup menu 800. In one embodiment, the processing component 92 of the IA mixed-structure system 90 may detect when the SME 100 interacts with the one or more model components of the SME model 612a and, upon detecting a predetermined interaction, may cause the user device 98 to display the popup menu 800 within the primary user interface 99 (e.g., within the model builder and AI augmentation user interface 400).

In one embodiment, the predetermined interaction may include, for example, clicking on the one or more model components, double-clicking on the one or more model components, hovering over the one or more model components, right-clicking on the one or more model components, and/or the like. In other embodiments, the processing component 92 of the IA mixed-structure system 90 may detect input (directed to interact with the one or more model components) of one or more hotkey, or a combination of hotkey and clicking/hovering over the one or more model components, for example. In one embodiment, the popup menu 800 may include one or more data field control 804 operable to, upon selection by the SME 100, cause the processing component 92 of the IA mixed-structure system 90 to modify, edit, delete, or create model data associated with the one or more component type the SME 100 has interacted with.

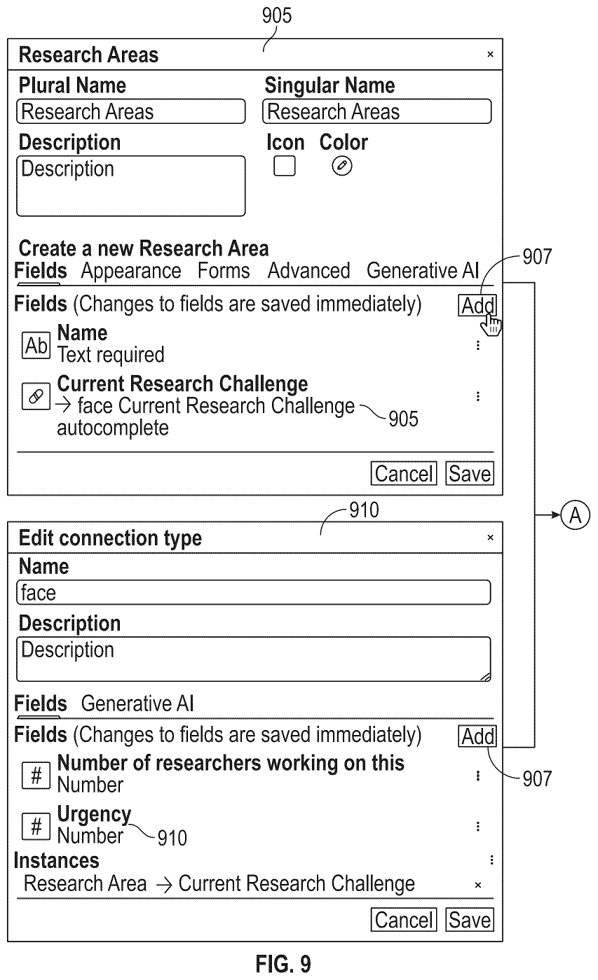

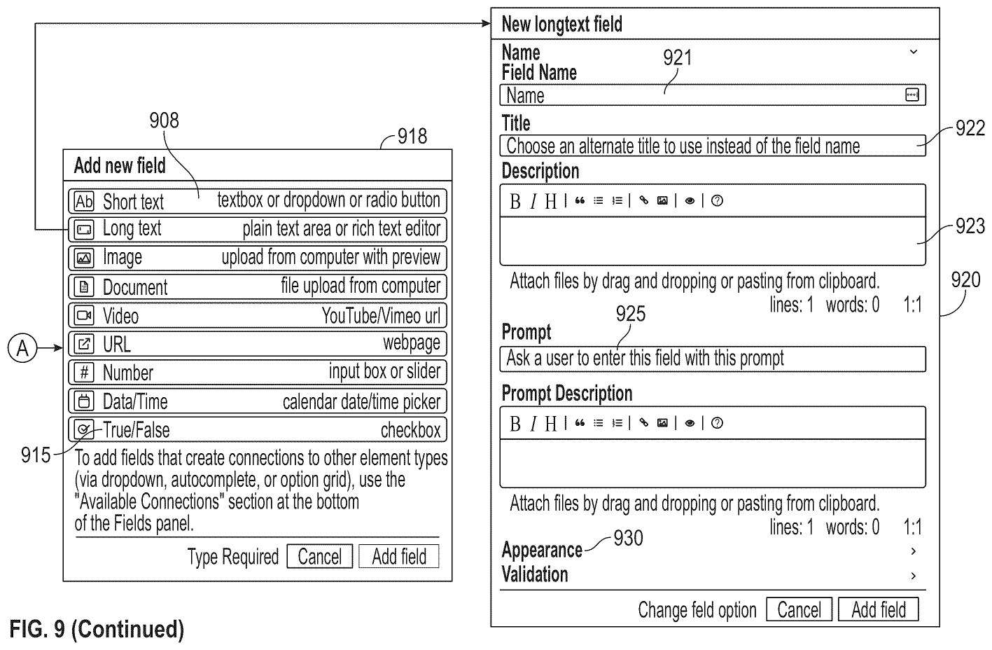

Referring now to FIG. 9, shown therein is a workflow diagram of an exemplary embodiment of a dataflow within a configuration user interface. In one embodiment, the processing component 92 of the IA mixed-structure system 90 may display an element type configuration UI 905 upon selection of a define data field control 804 (FIG. 8) associated with one or more model element types (such as the first model element type 600), or may display a connection type configuration UI 910 upon selection of a define data field control 804 (FIG. 8) associated with one or more model connection types (such as the connection type 605). In both the element type configuration UI 905 and the connection type configuration UI 910, the SME 100 may add one or more (strongly typed) data fields to the model definition by clicking an “Add” button 907 and then selecting from a list 908 of data types 915 in a field UI 918.

In one embodiment, each data type 915 has a configuration UI 920 associated therewith which then allows the SME 100 to input data type properties, such as by allowing the SME 100 to enter a type name for the data type 915 in a name input 921, a type title in a title input 922, and a type description in a description input 923. Additional inputs operable to receive input data type properties may also be included in the configuration UI 920 based on the data type 915 of the data field of the model component definition. For example, the configuration UI 920 may further support setting field configurations based on the data type 915 of the data field, such as if the data field has a data type 915 of “text”, the configuration UI 920 may support inputting a field configuration setting a character limit (if such a limit is desired); or if the data field has a data type 915 of “numeric”, the configuration UI 920 may support inputting a field configuration setting a numeric range (if such a range is desired); or, for example, if the data field has a data type 915 of “image”, the configuration UI 920 may support inputting a field configuration setting a particular aspect ratio (if so desired).

In one embodiment, the configuration UI 920 may further include a prompt input 925 operable to receive an input from the SME 100 indicative of a data field prompt displayed in the model builder and AI augmentation user interface 400 if the SME 100 is manually entering model data (e.g., at step 265, using the manual entry component 199). The data field prompt may be, for example, text that may be presented to the SME 100 by the processing component 92 when prompted to provide a value for the particular data field. In one embodiment, the configuration UI 920 may further include an appearance input 930 operable to receive one or more input from the SME 100 when the SME 100 is manually entering model data. In one embodiment, the appearance input 930 may be an input field selector operable to, upon selection by the SME 100, define one or more input field style, such as a dropdown list, combo box, calendar input, radio button, checkbox button, uncontrolled text box, text box, and/or the like, or a combination thereof.

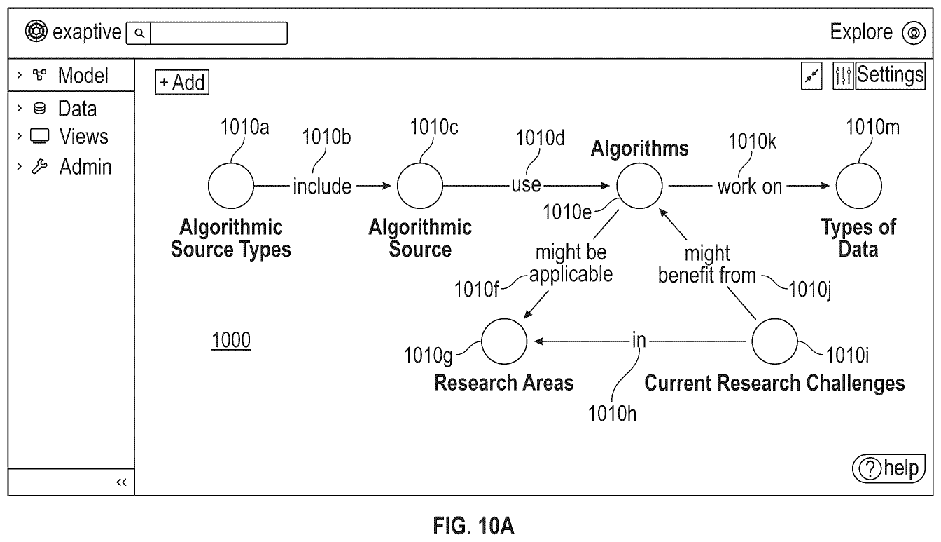

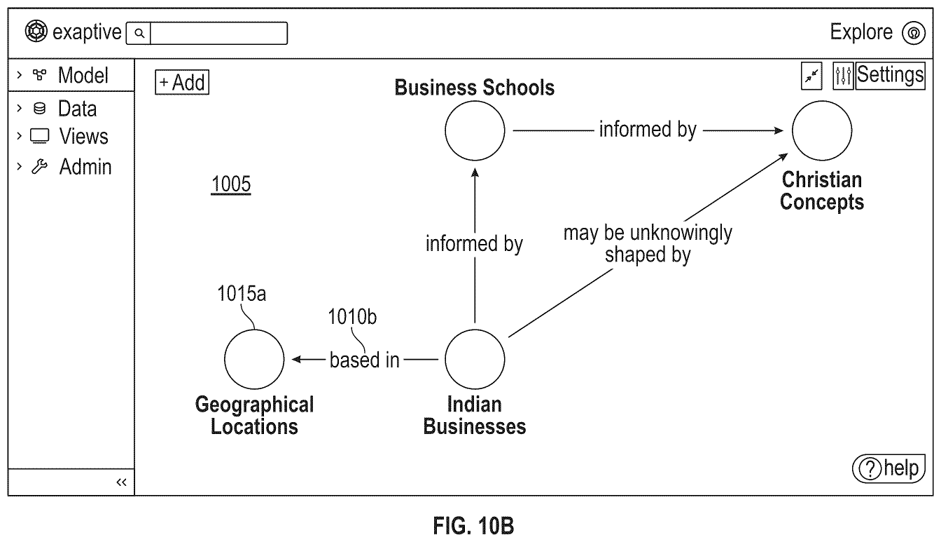

Referring now to FIGS. 10A-B, in combination, shown in FIG. 10A is a screenshot of an exemplary embodiment of a complex model constructed within the model builder and AI augmentation user interface 400, e.g., a first model 1000, and shown in FIG. 10B is a screenshot of an exemplary embodiment of the model builder and AI augmentation user interface 400 having a second model 1005, both constructed in accordance with the present disclosure. In one embodiment, the first model 1000 may be created by a first SME 100, while the second model 1005 may be created by a second SME 100. As shown, the first model 1000 displays a plurality of first component types 1010a-n associated with the first model 1000 created by a software architect SME interested in discovering more video game algorithm exaptations (as described above in relation to the SME model 612a). As shown, the second model 1005 displays a plurality of second component types 1015a-n associated with the second model 1005 created by a humanities professor exploring concepts related to the humanities professor's current research. These two very different models (the first model 1000 and the second model 1005) are shown to illustrate the domain-agnostic nature of the SME model builder 105 of the IA mixed-structure system 90.

FIG. 11 is a screenshot of an exemplary embodiment of a dataflow illustrating an association between a model element having an element type “Current Research Challenges” with a prompt template and associated AI integration configuration as constructed in accordance with the present disclosure. As shown, in the element type configuration UI 905, a generative AI menu item 1100 has been selected, thereby causing the processing component 92 of the IA mixed-structure system 90 to display a prompt template 1105 and display, on the user device 98, an autocomplete menu 1110, thus associating the second model element type 610 having the element type with the prompt template 1105, which will be used by the processing component 92 of the IA mixed-structure system 90 when communicating with the AI services 178. It should be understood that while the element type configuration UI 905 is shown as associating the second model element type 610 with the prompt template 1105, the connection type configuration UI 910 includes similar displays when the generative AI menu item 1100 (not shown) of the connection type configuration UI 910 is selected. In this way, any model component of the one or more model components of the SME model 110 may be associated with one or more prompt templates 1105 to be used by the processing component 92 during communication with the AI services 178 to support AI augmentation.

In one embodiment, because the IA mixed-structure system 90 has the benefit of the structured format of the model definition and associated semantics, the processing component 92 of the IA mixed-structure system 90 is able to provide autocomplete assistance (via the autocomplete menu 1110) to the SME 100 as the SME 100 composes the one or more prompt templates 1105, which may include one or more placeholders 1112 where the processing component 92 of the IA mixed-structure system 90 will substitute in values from data fields when converting the prompt templates 1105 to dynamic prompts (e.g., for the one or more CCP) for the AI services 178 to provide a service response to. For example, the processing component 92 may analyze the metadata of the particular model component and generate autocomplete entries based on the one or more fields definitions 125.

In one embodiment, the SME 100 is not restricted to a single prompt template 1105, but may add as many prompt templates 1105 (such as a prompt template 1105b) as desired by selecting, for example, a new prompt input 1115 to any of the one or more model components. In addition to the text of the prompt template 1105 with the placeholders 1112, the processing component 92 of the IA mixed-structure system 90 may further store (e.g., save in the memory 94) AI integration definitions 1120 about each prompt template 1105a including, for example, one or more associated AI service 1125 indicative of the one or more AI service 178 to which the prompt template 1105a may be sent; one or more response format 1130 for the service response; an SME validation indication 1135 indicative of whether the validation of service responses should include manual SME validation (e.g., at step 350, FIG. 3); and/or an automatic validation indication 1140 indicative of whether the validation of service responses should include automated validation (e.g., at step 345, FIG. 3).

In one embodiment, the SME 100 may provide a first AI service 178 and a second AI service 178 and, when preparing the prompt templates, may associated the prompt templates 1105a to one or more of the first AI service 178 and the second AI service 178, for example, based on capabilities of each particular AI service 178. For example, in one embodiment, if the SME 100 selects a particular field definition have a data type to be included in a particular AI prompt template, the processing component 92 may allow the SME 100 to associate the particular AI prompt template with certain AI services 178 that are compatible with that data type, e.g., that can receive as input or produce as output, the data type. That is, if the data type includes an image, the processing component 92 may limit the AI services 178 provided to the SME 100 for association with the AI prompt template to only those AI service 178 operable to receive the image as an input.

In one embodiment, if automated validation is desired the SME 100 may provide a URL endpoint (e.g., pointing to the automatic validation subsystem 185) as the automatic validation indication 1140 to which the processing component 92 may send the service response for automatic validation. In other embodiments, the automatic validation indicator 1140 may be a checkbox, or may include a combo-box allowing the SME 100 to select from one or more (predetermined) validation service or other URL.

FIG. 12 is a screenshot showing the first model 1000 (e.g., an algorithmic exaptation model) annotated with the prompt templates associated with each of the one or more model components, and illustrates a variety of ways that placeholders (e.g., placeholders 1112) can be embedded within prompt templates, including: no placeholders as shown in prompt template 1200, a placeholder 1202a to a connected model element as shown in prompt template 1205, a placeholder 1202b to a specific data field or connection of a connected model element as shown in prompt template 1210, and multiple placeholders 1202c-d to different connected model elements and/or different fields of connected model elements as shown in prompt template 1215. Also shown is a prompt template 1201, for a model component having an “algorithmic sources” element type, having a placeholder 1202e.

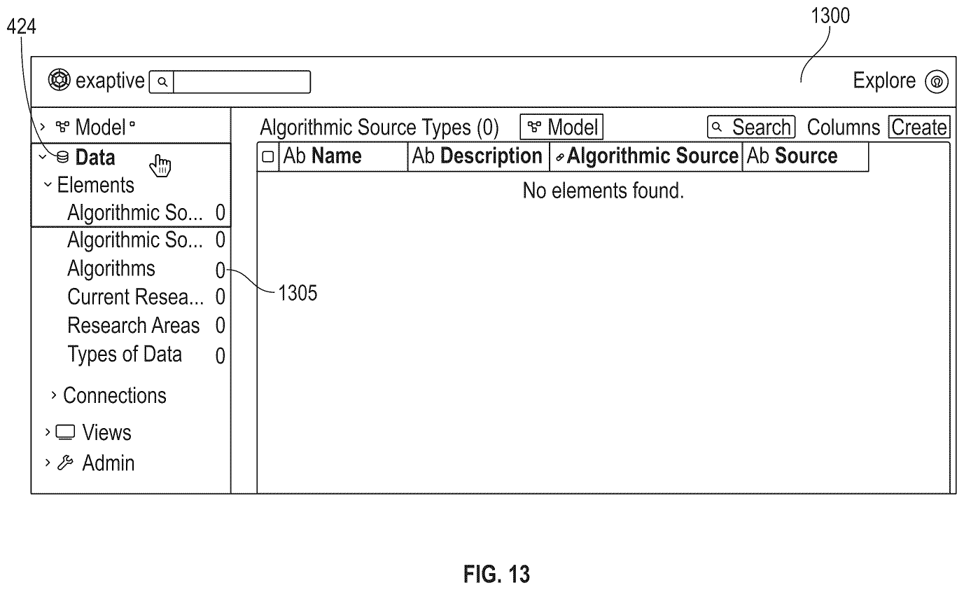

Referring now to FIG. 13, shown therein is a screenshot of an exemplary embodiment of a data inspection user interface 1300 constructed in accordance with the present disclosure. The data inspection user interface 1300 may send one or more signals to the processing component 92 of the IA mixed-structure system 90 indicative of an interaction between the SME 100 and the data inspection user interface 1300. The processing component 92 may receive an input from the SME 100, such as by the SME 100 clicking on the data menu item 424 to cause the data inspection user interface 1300 to be displayed in the primary user interface 99, e.g., by executing the SME interaction and data view component 195. Generally, the data inspection user interface 1300 enables the SME 100 to interact with the model data of the SME model 110, such as model data stored in the model data storage 155. Because the SME model 110 has just been created, without any manual entry of data (e.g., HI data population process 265, FIG. 2) or any data population via AI augmentation (e.g., AI data population process 270, FIG. 2), there is no model data associated with the SME model 110 and a data count for each model components is zero as shown by a data count indicator 1305 associated with each model component. This illustrates that the SME model 110 is a system construct separate from the model data which may be contained therein and can stand alone.

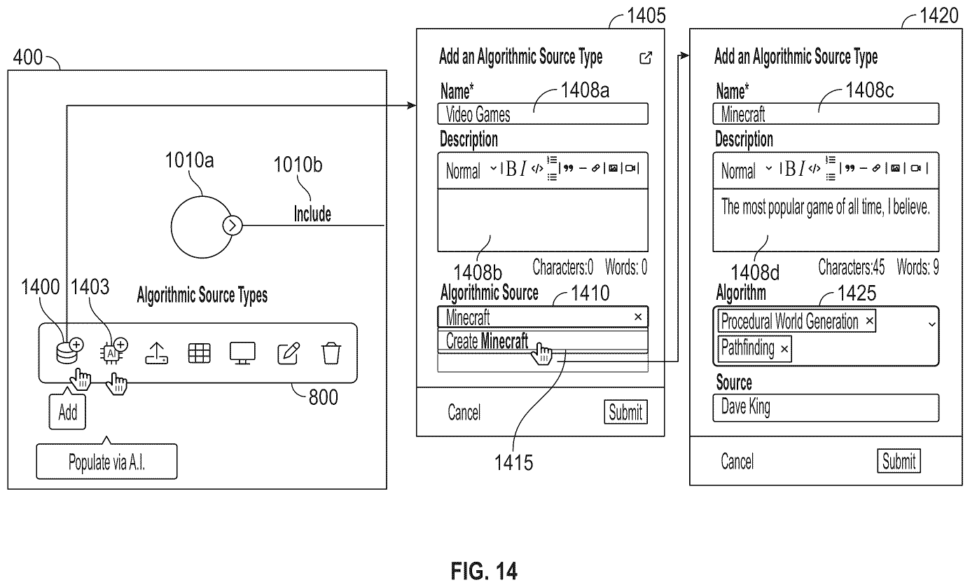

FIG. 14 shows a workflow diagram of an exemplary embodiment of a manual data population user interface constructed in accordance with the present disclosure. In one embodiment, the SME 100 may access the popup menu 800 from the model builder and AI augmentation user interface 400 (as described above) where the SME 100 may select one of a manual data control 1400 or an AI data control 1403.

Upon selection of the manual data control 1400, the processing component 92 may cause a data entry modal 1405 to be displayed on the primary user interface 99 which provide one or more input field 1408a-n based on the component type 1410 of the one or more model component selected and into which the SME 100 may (manually) input model data.

In one embodiment, the data entry modal 1405 may provide a create new element and corresponding connection to new element input 1415, upon which selection, the processing component 92 may display a second data entry modal 1420 which provides the one or more input fields 1408a-n based on the component type of the (newly created) element. Similarly, the second data entry modal 1420 may provide a create new element input, upon which selection, the processing component 92 may display the data entry modal 1405 or to display one or more connected model elements 1425 to which the component type is associated. This iterative creation can proceed to any level of depth and allow for multiple components (e.g., model element types and/or connection types) to be created at different levels/depths of the model hierarchy.

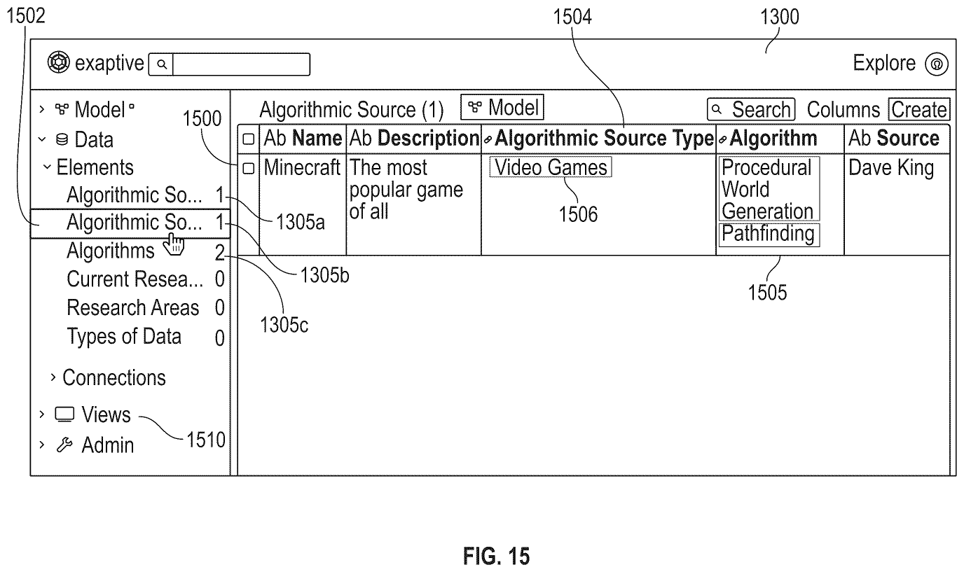

Referring now to FIG. 15, shown therein is a screenshot of an exemplary embodiment of the data inspection user interface 1300 having at least one algorithmic source 1500 constructed in accordance with the present disclosure and having manually entered data for the model. As shown, there is now a “1” shown by a first data count indicator 1305a, a “1” shown by a second data count indicator 1305b, and a “2” shown by a third data count indicator 1305c, thereby indicating that model data exists for 1 algorithmic source type, 1 algorithmic source, and 2 algorithms associated with the data model. In other words, there is a first element instance of the model element type “Algorithmic Source Type” (e.g., an instance of component type 1010a, FIG. 10A), there is a second element instance of the model element type “Algorithmic Source” (e.g., an instance of component type 1010c), and there are two instances of the model element type “Algorithms” (e.g., two instances of component type 1010e).

As shown, an algorithmic source menu item 1502 is selected causing the processing component 92 to display the at least one algorithmic source 1500 in the data inspection user interface 1300. The algorithmic source 1500, “Minecraft”, is shown in the table-based UI 1504 which shows that model element's linkage to instances of other model elements 1505. The SME 100 is then able to select a view menu item 1510 to cause the processing component 92 to display a data view user interface 1600 (below) to display the model data associated with the SME model 110 as a form of interactive analysis and a potential launching point for further data entry either manually or via AI augmentation.

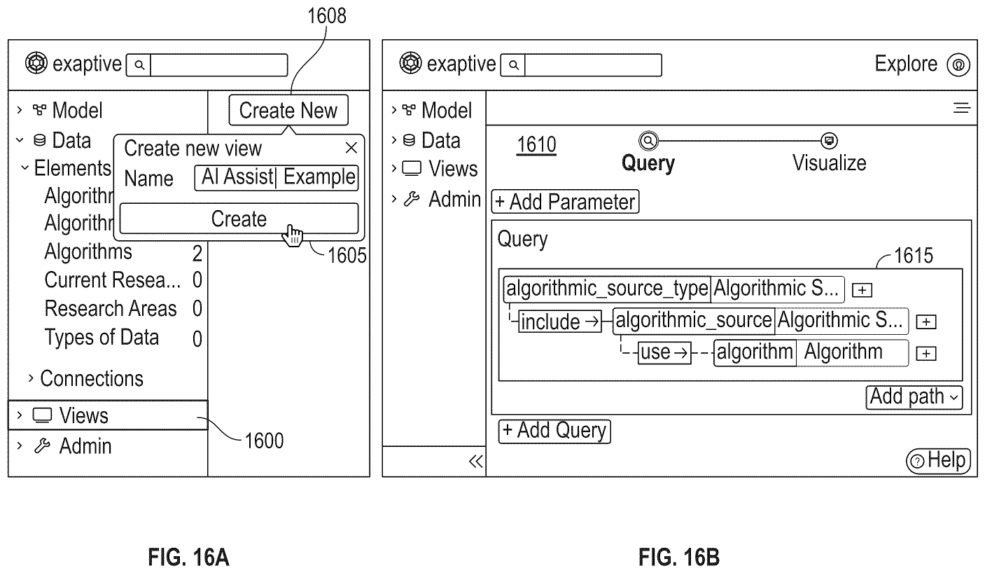

FIG. 16A shows a screenshot of an exemplary embodiment of the data view user interface 1600 constructed in accordance with the present disclosure. As shown, when no data view has been created, the data view user interface 1600 may have a user interface 1605 without any saved views indicated and a create view button 1608 operable to, upon selection by the SME 100, cause the processing component 92 to display a view builder user interface 1610 thereby allowing the SME 100 to construct a query of the model data that is used to create a new named view (as shown in FIG. 16B). In one embodiment, the view builder user interface 1610 enables the SME 100 to traverse the model element types and connection types of the SME model 110 to form a query 1615 that, when executed by the processing component 92 of the IA mixed-structure system 90, determines which model data associated with the new named view is shown.

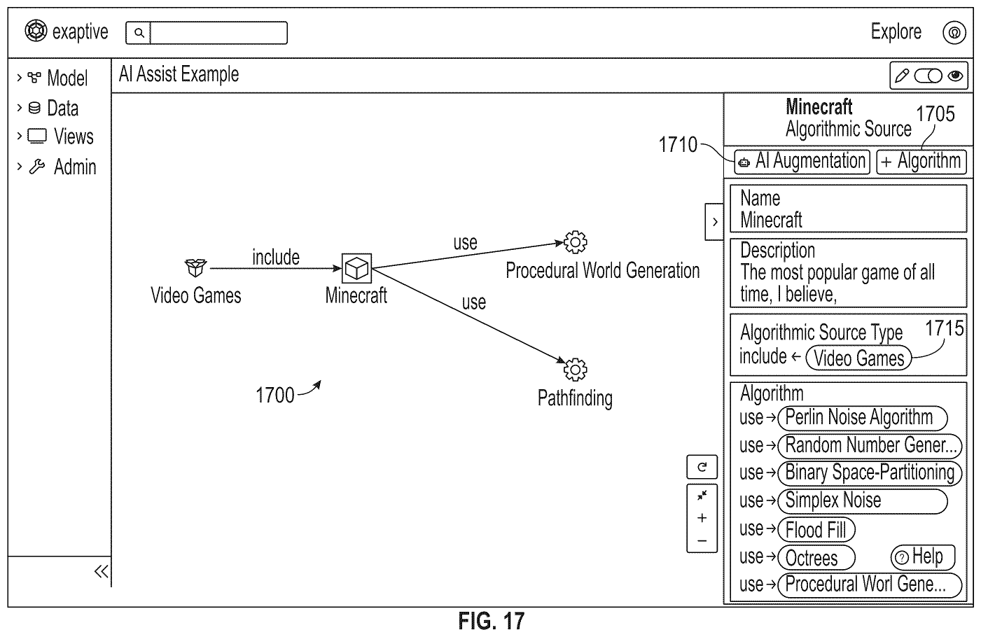

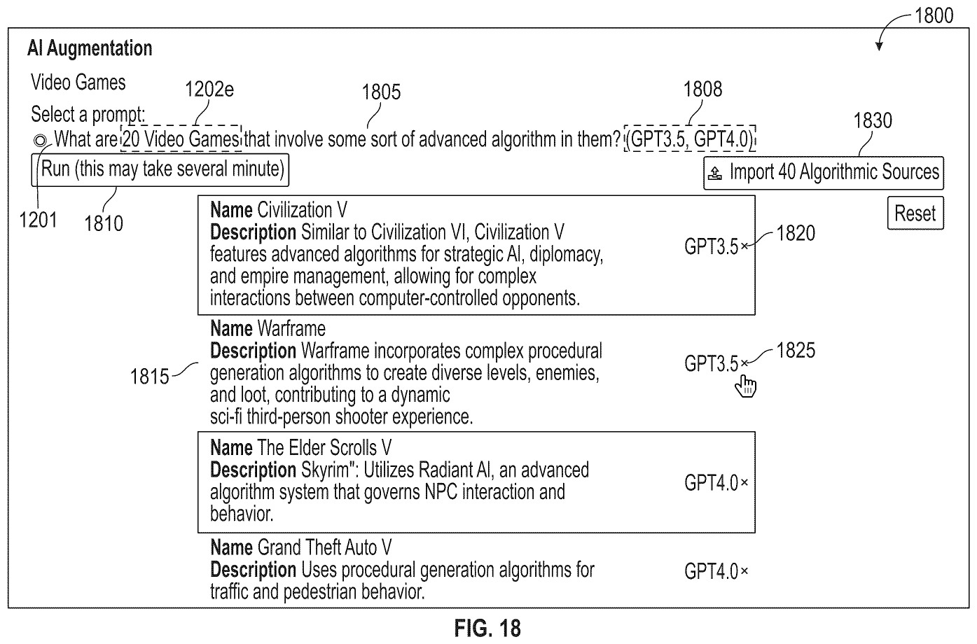

FIG. 17 shows a screenshot of an exemplary embodiment of a named view 1700 created using the view builder user interface 1610 and based on the first model 1000 (e.g., the algorithm exaptation model), with the model data having been manually entered into the first model 1000 (described above in reference to FIG. 15), and the query 1615 provided to the view builder user interface 1610. Views within IA mixed-structure system 90 are not just read-only visualizations, but data applications in which the SME 100 can take action based on the named view 1700. Such actions may include continuing to manually add model data in a model-aware way, for example, adding additional algorithms (e.g., component type 1010e) to be connected to the selected “Minecraft” element instance via a new linked element button 1705 (shown as “Algorithm” based on the relationships between the element type of “Algorithm” and the element type of “Algorithmic Source” in the first model 1000), or using AI augmentation to bulk populate model data based on one or more selected model element instances in the named view 1700 thereby establishing an augmentation entry point by selecting an AI augmentation button 1710, that is, because the SME 100 has selected the element instance of “Minecraft”, when the SME 100 then selects the AI augmentation button 1710, the selected element instance of “Minecraft” is provided as the augmentation entry point. Also shown is a “Video Games” element instance 1715 associated with an “Algorithmic Source Type” model element type (e.g., “video games” 1506, FIG. 15). Upon selection of the element instance 1715, the processing component 92 may display an AI augmentation UI 1800 on the user device 98 as shown in FIG. 18 below.

Referring now to FIG. 18, shown therein is a screenshot of an exemplary embodiment of an AI augmentation UI 1800 constructed in accordance with the present disclosure. The prompt template 1201 associated with the model element type of “Algorithmic Source Type” (e.g., component type 1010a, FIG. 10) has had the placeholder 1202e (of FIG. 12) updated to reflect a “Video Games” augmentation entry point, resulting in a dynamic prompt 1805 to be directed to two AI services 178, shown as “(GPT3.5 and GPT4.0)” 1808 (e.g., the associated AI services 1125, FIG. 11). When the SME 100 “executes” this AI augmentation by clicking a “Run” button 1810, the user device 98 displaying the AI augmentation UI 1800 transmits an augmentation message to the processing component 92. The processing component 92 receives the augmentation message and, executing the AI augmentation engine 160, creates a coordinated call package (e.g., by executing the orchestration engine 165) as shown in FIG. 3 at step 320, which involves creating optimized prompts for both of the two AI services 178 (i.e., the GPT 3.5 and GPT 4.0 services). As discussed above in more detail, instructions regarding the desired response format may be included in the optimized prompts. In this way, the service responses are received from the AI services 178 such that the service responses conform to the response format, such as a list of “Name/Description” pairs, which may be the response format 1130 associated with the dynamic prompt 1805 in the AI integration definitions, e.g., AI Augmentation configuration information, (shown in FIG. 11).

In one embodiment, the processing component 92 of the IA mixed-structure system 90 may receive the service results from the AI service 178 and parse the service results into the structured response (as described above). The processing component 92 may store the structured response to the memory 94 and may further present the structured response to the SME 100 by causing the AI augmentation UI 1800 to display one or more structured response entries 1815. In one embodiment, the processing component 92 may further include an annotation 1820 of the AI Service 178 responsible for a particular service response.

In one embodiment, the SME 100 is able to curate these structured response entries 1815, such as by selecting a delete input 1825 associated with a particular structured response entry 1815, thereby causing the processing component 92 to delete the structured response entry 1815 (either from the AI augmentation UI 1800 and/or from the memory 94). In one embodiment, the processing component 92 may not store the structured response to the memory 94 (such as into the model data storage 155), until directed to do so by the SME 100, such as by selection of a “import” input 1830. When satisfied with the results, the SME 100 can import the structured response into the data model as a structured “Algorithmic Source” element type, e.g., the element type associated with results from this augmentation entry point and dynamic prompt 1805. As shown in FIG. 18, in one embodiment, even though the dynamic prompt 1805 asked for 20 items, 40 items are available for import (as indicated by import button 1830) because the dynamic prompt 1805 was sent to two different AI services 178 (shown by sources 1808) with each AI service 178 providing 20 items in the respective service response.

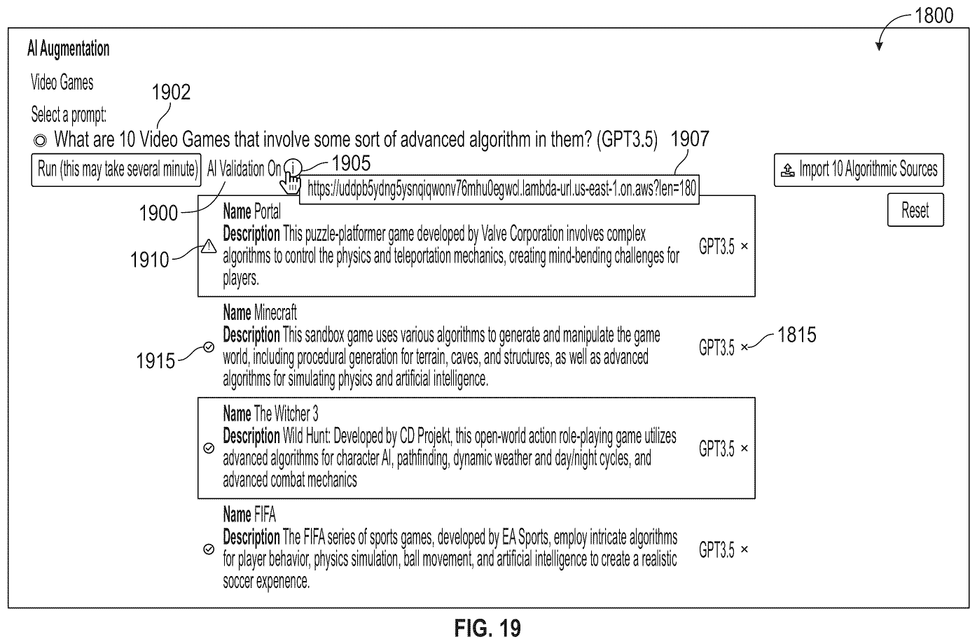

FIG. 19 shows the AI augmentation UI 1800 of FIG. 18, with the exceptions that additional service responses have been processed through the automated validation subsystem 185 of the AI validation engine 180 prior to the processing component 92 provided the service responses to the SME 100 as a structured response entry 1815. The processing component 92 has provided an automated AI validation indicator 1900 to the AI augmentation UI 1800, thereby showing that automated validation has been enabled for a dynamic prompt 1902 and has provided a URL indicator 1905 indicative of a specific URL endpoint 1907 of an automated validation service. The automated validation service has annotated the service responses with the results of the validation check for each structured response entry 1815. Structured response entries 1815 that could not be validated are indicated by a first validation result 1910, which may be different from a second validation result 1915 indicative of structured response entries that were able to be validated.

In one embodiment, service responses that fail validation (e.g., have the first validation result 1910) are not automatically removed by the processing component 92 (as described above) from the structured response entries 1815, for example, if manual SME validation is also enabled. If manual SME validation is enabled, the processing component 92 may display the structured response entries, including those having the first validation result 1910 and the second validation result 1915, such that the SME 100 may validate the automated validation performed by the processing component 92 executing the AI validation engine 180. However, in order to support scalability once the SME 100 is confident in a quality of the service responses and the quality of the automated validation checks being performed by the processing component 92 executing the AI validation engine 180, if SME validation is disabled, then the processing component 92 may automatically import the service responses that pass the automated validation check, into the model data, such as by storing those service responses in the model data storage 155.

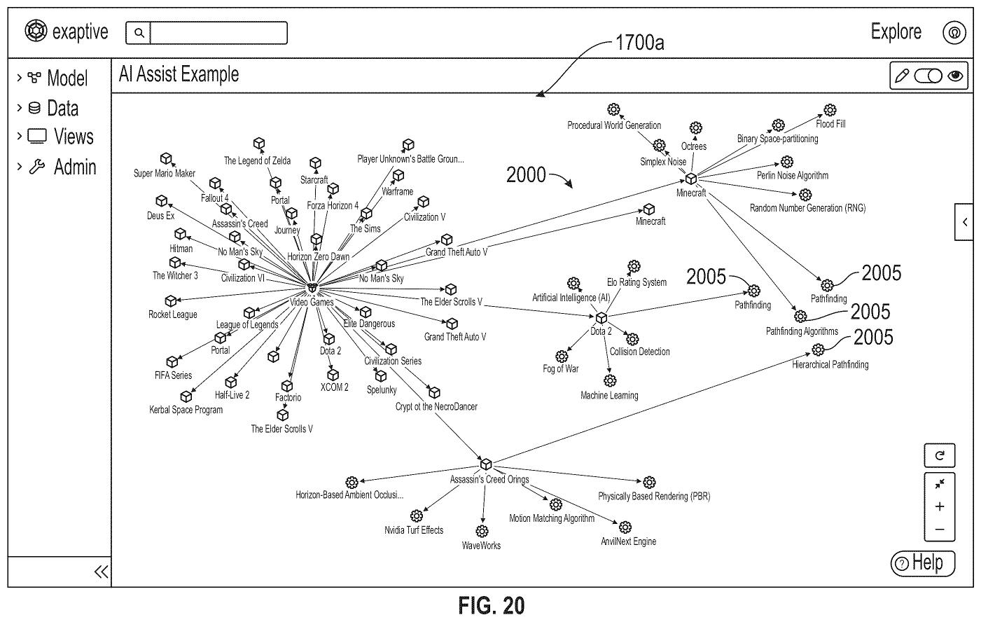

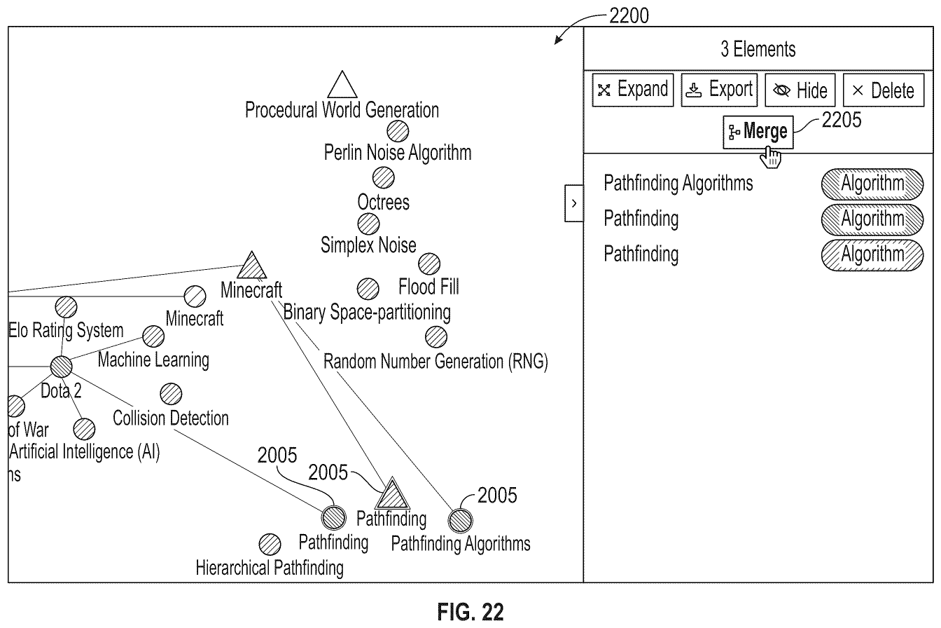

Referring now to FIG. 20, shown therein is a screenshot of an exemplary embodiment of a named view 1700a constructed in accordance with the named view 1700 of FIG. 17 based on a model instance the first model 1000 (e.g., the algorithm exaptation model) with the exception that the first model 1000 has been updated to further include model data generated as a result of multiple AI augmentations at different augmentation entry points 2000. Multiple “Pathfinding” algorithm element instances 2005 were created as a result of the augmentation. Such multiplicity (e.g., the multiple element instances) may be handled in different ways. In one embodiment, model element instances returned with the same element name are not automatically merged because the element descriptions may be different, but the SME 100 is able to interact with the model data as shown in FIG. 22, discussed below, to merge the multiple element instances manually, if so desired.

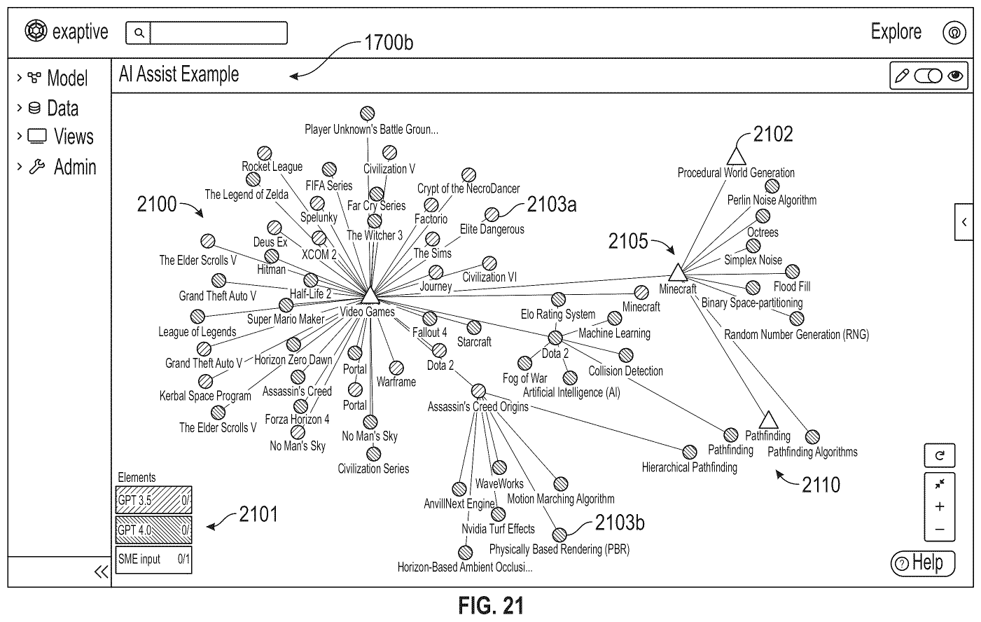

Referring now to FIG. 21 shown therein is a screenshot of another exemplary embodiment of a named view 1700b constructed in accordance with the named view 1700a of FIG. 20 with the exception that the named view 1700b is displayed with a different styling (as shown in key 2101) of the model elements so as to show that the named view 1700b contains data from three different sources: model elements manually entered by the SME (shown by a first indicator 2102 (triangle) having a first property (a first color/pattern), e.g., as triangles having no infill), model elements that are the result of GPT3.5 augmentation (shown by a second indicator 2103a (circle) having a second property (a second color/pattern), e.g., as circles with wide-spaced lines), and model elements that are the result of GPT4.0 augmentation (shown by a second indicator 2103b (circle) having a third property (a third color/pattern), e.g., as circles with close-spaced lines).

A first augmentation entry point 2100 added video game “algorithmic sources” from both GPT3.5 and GPT4.0 (as indicated by the second indicators 2103—circles), a second augmentation entry point 2105 added specific algorithm elements to the “Minecraft” algorithmic source from GPT4.0 (as indicated by the second indicators 2103b having the third property—close-spaced lines) that sit alongside the algorithms originally entered manually by the SME 100 (indicated by the first indicator 2102 having the first property-triangles with no in-fill). The multiple pathfinding-related element instances 2110 represent a combination of user entered data and GPT4.0 augmented data. In this way, the IA mixed-structure system 90 maintains generality, that is, the IA mixed-structure system 90 is not tightly coupled to using a particular AI service 178 (such as GPT) for AI augmentation—any AI service 178 can be utilized by the processing component 92 so as long as the AI service 178 is registered in the AI services registry 145 and so long as the AI augmentation engine 160 is updated with the appropriate logic to be executed by the processing component 92 for transforming dynamic prompts into coordinated call packages with optimized prompts based on the requirements of the AI service 178.

Referring now to FIG. 22, shown therein is a screenshot of an exemplary embodiment of a merge user interface 2200 constructed in accordance with the present disclosure. As shown, the SME 100 may select one or more of the multiple element instances 2005 and, upon selection of a merge button 2205, may cause the processing component 92 to merge the selected ones of the multiple element instances 2005 into a single element instance (shown as element instance 2313 in FIG. 23A, discussed below). This is another example of SME data curation, this time occurring after the import of augmentation results.

In one embodiment, the processing component 92 may update the model data storage 155 to include only the single element instance having a combination of the connections of the selected ones of the multiple element instances 2005. In one embodiment, the SME 100 may be provided with an opportunity to select an element description from the selected ones of the multiple element instances 2005 to use as an element description of the single element instance, or may be provided with a UI to input a new element description for the single element instance.

Referring now to FIGS. 23A-B, shown therein are screenshots of another exemplary embodiment of a named view 1700c constructed in accordance with the named view 1700a of FIG. 20 with the exception that the named view 1700c includes additional model element instances resulting from continued AI augmentation traversing the SME model 110.

In one embodiment, each model element instance of the first model 1000 in the named view 1700c has an icon 2300 corresponding with the model components 1010 (FIG. 10) of that particular component type in the first model 1000 (shown in FIGS. 10, 23B) and each AI augmentation using the prompt templates (shown in FIG. 12).

Starting from an “algorithmic source type” element type of “Video Games” (element instance 2305) having the icon 2300a, which was an instance of an algorithmic source type manually entered by the SME 100, a variety of specific video games 2310 (as element instances having an “algorithmic sources” element type were imported via AI augmentation. Some of these video games 2310 were chosen as augmentation entry points using the AI service 178 to augment the augmentation entry points for specific algorithms (model elements having the “algorithm” element type) the video games 2310 were known to employ, for example, video game 2310a titled “Assassin's Creed Origins” uses an element type of “Algorithm” including a “Hierarchical Pathfinding” element instance 2315. The hierarchical pathfinding element instance 2315 was used as an augmentation entry point for the AI service 178 to characterize the specific “Types of Data” element type for element instances 2320 consumed by the “Hierarchical Pathfinding” element instance 2315. Once the “Hierarchical Pathfinding” element instance 2315 was linked to “Types of Data” element instances 2320, an additional augmentation path was made possible in which the AI could augment the same entry point (the Hierarchical Pathfinding element instance 2315) but with a different prompt (e.g., using a different prompt template).

In one embodiment, prior to the import of “Types of Data” element instances 2320, the only prompt template that could be converted to a dynamic prompt based on the model data available in the SME model 110 was “What types of data are usually analyzed by a [Algorithm] algorithm?” (e.g., prompt template 1203, FIG. 12). However, after executing prompt template 1203 and populating the model data with “Types of Data” element instances 2320, a new prompt template became resolvable: “What research areas produce many of the types of data in the following list: [Algorithm. Types of Data]” (e.g., prompt template 1210, FIG. 12). Executing prompt template 1210 allowed for AI augmentation of the model data with “Research Areas” element instances 2325, e.g., instances of model elements having the “Research Areas” element type. Two of these research areas element instances 2325 include a “Telecommunication Engineering” instance 2330 and an “Environmental Science” instance 2335, which the processing component 92 may then use as augmentation entry points to determine specific research question element instances 2340 in those research areas element instances 2325 that might benefit from leveraging hierarchical pathfinding algorithms from the hierarchical pathfinding element instance 2315.

Referring now to FIG. 24, shown therein is an illustration of an exemplary embodiment of the named view 1700c of FIG. 23A further showing description data for each element instance. For example, following one particular path down the first model 1000 with the benefit of the element descriptions illustrates how the IA mixed-structure system 90 solved the technical problems faced in domain-agnostic research systems: with the SME model 110 that defines how the SME 100 may solve the complex problem of finding potential algorithmic exaptations from videos games that could open “new frontiers” in science, as described above, a few button clicks (from the perspective of the SME 100) that converted the service responses having data in an unstructured format from a general-purpose generative AI service 178 into the structured format of element types described in the model definitions of the data model, it is shown that “Assassin's Creed Origins” video game 2310a is a good example of a video game element 2400 using advanced algorithms based on a first description 2401 detailing that “The Assassin's Creed series, including Origins, incorporates navigation algorithms for AI-controlled characters, enabling realistic parkour movements and crowd behavior.”

When this video game element 2400 is AI augmented, as performed by the processing component 92 to provide model data in more detail, it is shown that the video game instance 2400 leverages “Hierarchical Pathfinding” algorithms element instance 2315 which, as shown from another augmentation performed by the processing component 92, are a type of algorithm that often consume connectivity data (shown in description 2410a), navigational data (shown in description 2410b), graph data (shown in description 2410c), and spatial data (shown in description 2410d).

The fourth augmentation performed by the processing component 92 shows that both “Telecommunication Engineering” (element instance 2330) and “Environmental Science” (element instance 2335) are research areas (“Research Areas” element types) that produce similar sorts of data to what hierarchical pathfinding algorithms consume (as detailed in description 2415), and the fifth augmentation performed by the processing component 92 then provides highly-specific research questions (shown in descriptions 2420a-e) that might benefit from leveraging hierarchical pathfinding algorithms, like are used in the Assassin's Creed Origins video game. Reading a few of the selected research questions shows the degree to which the IA mixed-structure system 90 has been able to overcome the technical problem of drift in AI service responses and is able to maintain the AI's focus (e.g., focus of the service responses received from the AI services 178) on the context of the problem and the context of a specific augmentation path chosen by the SME 100 to explore—potentially applying hierarchical pathfinding algorithms in the field of telecommunication engineering or environmental science. These selected research questions include:
“How to boost network security by employing Hierarchical Pathfinding algorithms? Pathfinding algorithms could potentially detect unusual data traffic paths, which could indicate cyber-security threats or system vulnerabilities.” (description 2420a).
“How can Hierarchical Pathfinding expedite mobile networks' data transfer efficiency, especially when users are on the move? Utilizing pathfinding algorithms could streamline the process of cell tower switching and significantly improve the experience of mobile users.” (description 2420b)
“Could the use of hierarchical pathfinding offer better forecasting for climate-induced migration patterns, considering factors such as resource access, conflict and natural disasters? More refined pathfinding could help us prepare and respond to the mass movement of climate refugees.” (description 2420c)
“How can hierarchical pathfinding improve models of waste dispersal in both water bodies and air, helping predict the impact and spread of pollutants? This could aid in identifying potentially affected areas and help devise more effective waste management practices.” (description 2420d)
“Could the implementation of advanced hierarchical pathfinding algorithms help identify areas especially susceptible to wildfires based on vegetation, terrain, and prevailing wind directions? More refined pathfinding algorithms might allow simulation software to more realistically predict how wildfires might spread.” (description 2420e)

The research questions shown in the descriptions 2420 are not the only AI returned answers that show awareness of both context and state-the descriptions 2410 of the data types are not general descriptions about quite broad types of data, but highly specific to the way that those data types are relevant to hierarchical pathfinding algorithms:
Connectivity Data: “This refers to data about how different nodes are interconnected or how easy it is to move between them. For example, in a transportation network, such as a city's public transit system, certain locations may have direct connections, while others might require several transfers. This kind of data is crucial for a hierarchical pathfinding algorithm in identifying optimal routes.” (description 2410a)
Navigational Data: “Information regarding the rules or restrictions of navigation within a network can also be factored into hierarchical pathfinding. This might include things like one-way paths, prohibited areas, weight limits, or time-related factors such as traffic conditions or store hours.” (description 2410b)
Graph Data: “Graph data consists of nodes and the relationships between them, often referred to as edges. In the context of hierarchical pathfinding, these nodes would represent different locations within a space, whether physical or virtual, and the edges would represent the possible paths between them. These algorithms make calculations based on this data to find the most efficient path.” (description 2410c)
Spatial Data: “This type of data is related to the positions, shapes, or orientation of the nodes in a network. Hierarchical pathfinding algorithms often take spatial data into account when determining the quickest path, as this allows them to consider factors like distance, terrain, obstacles, and other geographic or spatial elements that could influence the route.” (description 2410d)

Similarly, descriptions 2415 of the Research Areas also stay aligned to the context of the SME model 110. Because the SME model 110 was provided to connect research areas to algorithms based on the types of data the algorithms produce, the descriptions 2415 of the research areas are with regards to how the types of data described above are produced in that field of the research area. The descriptions 2415 of the research areas include:
Telecommunication Engineering: “This field is concerned with the design, manufacture, and operation of telecommunication devices, networks and systems. It leverages graph data, connectivity data, and spatial data to build and use complex networking systems, maintain network structure and manage global telecommunication networks” (description 2415a of element instance 2330)
Environmental Science: “This interdisciplinary academic field integrates physical, biological and information sciences (including but not limited to ecology, physics, chemistry, biology, soil science, geology, atmospheric science etc.) to the study of the environment, and the nature and impact of human interactions with it. It often uses spatial, navigational, and connectivity data in researches such as wildlife tracking, climate change modeling, and pollution spread.” (description 2415b of element instance 2335)

Notice that while overall context remains consistent with exapting video game algorithms to research fields, the specific context for each model element varies based on the way the SME 100 has laid out the first model 1000. That is, the descriptions of video games (description 2401) are within the context of their algorithms (element instance 2315), the descriptions of algorithms (description 2405) are within the context of the video games (element instance 2305) from which the algorithm element instances 2315 are sourced, the descriptions 2410a-d of data types element instances 2320 are within the context of one specific algorithm that consumes the data types element instances 2320, the descriptions 2415a-b of the research area element instances 2330, 2335 are within the context of which of the multiple specific data type element instances 2320 the research area element instances 2330, 2335 produce, and the descriptions 2420a-e of research question element instances 2340 are within the context of how the specific algorithm element instance 2315 might be able to be employed to answer the research question element instances 2340 of the research areas element instances 2330, 2335.

The outcome when the alternative to an efficient automated process is a slow and tedious one is not that the same work occurs just more slowly, it is that the work often is not done at all or is not done at nearly the same scale. The increasing burden of knowledge has made it impossible, in any meaningful way, to perform the slow manual version of what this disclosure automates. Part of the reason that people do not tackle the slow manual method is because of the recognition that anything an SME finds in the journey might cause the SME to change their “idea for solving” and have to return to the beginning of the process anew. The current disclosure changes that need for iterative solving from being a hindrance to being a streamlined part of the creative process. In this way, the IA mixed-structure system 90 disclosed herein solves the technical issue of reducing iterative complexity thereby decreasing the computation time needed to perform AI augmentation while maintaining AI focus and proactively accounting for AI hallucinations.

It is important to recognize that the results shown in FIG. 24 represent just one path through the first model 1000 based on just one algorithm of interest (element instance 2315) and just one potential “idea for solving” algorithmic exaptation as represented by the SME model 110. More fully augmented model data allows the SME 100 to review hundreds of suggested algorithmic exaptation research question element instances 2340 across dozens of research areas element instances 2330, 2335 based on dozens of algorithms (element instances 2315) across dozens of cutting-edge video games (element instances 2305).

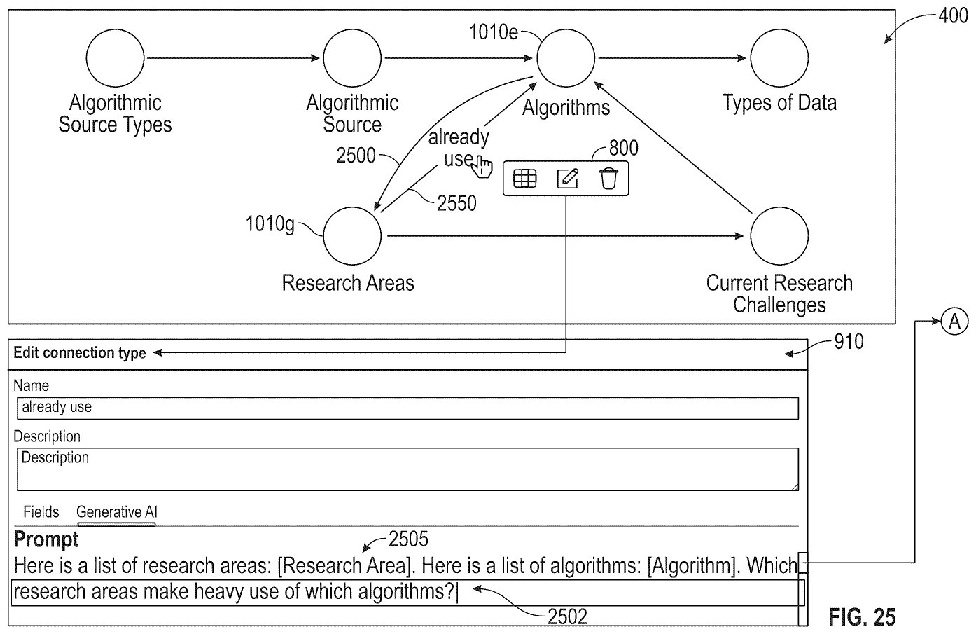

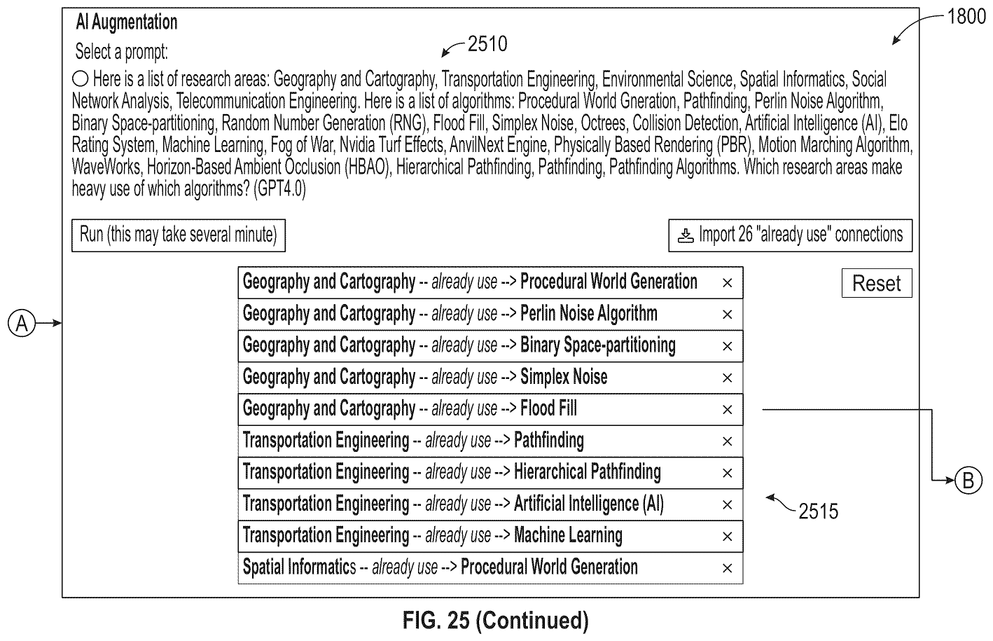

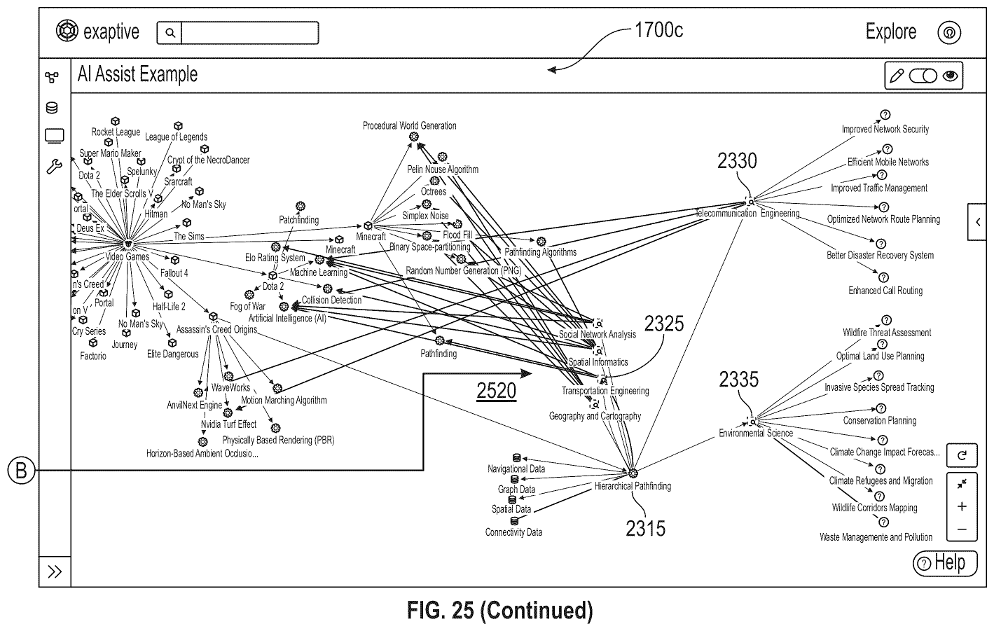

All of the actions: increasing the inventory of source types, sources, algorithms, data types, research areas, and research challenges, or shifting the focus thereof, are all constrained by the SME model 110 built by the SME 100 and annotated with AI prompt templates (shown in FIG. 12), but this SME model 110 is not a hardcoded part of the IA mixed-structure system 90. Review of the results will likely change the SME's “idea for solving” and the SME 100 will evolve, edit, or modify the SME model 110 and the AI prompt templates as a result. For example, during creation of the first model 1000, the SME 100 may start with a model that ended with the research field in which an algorithm might be used (e.g., component type 1010g), but did not include the concept of the “Current Research Challenge” model element type (e.g., component 1010i). Then, after reviewing the initial augmentation results produced by this smaller model, the SME 100 (e.g., at step 250 of the user workflow 200 shown in FIG. 2) may realize additional specification is required in order to understand exactly how a particular algorithm might contribute meaningfully to a particular research area (e.g., component 1010i). The SME model 110 (first model 1000) may then be updated by the SME 100 to include the “Current Research Challenge” model element type (e.g., component 1010i), and AI augmentation was continued (e.g., the user workflow 200 may be performed), without having to restart construction of the SME model 110 from scratch. Another example of evolving the SME model 110 after reviewing the results (e.g., step 250) is discussed below and shown in FIG. 25.

Referring now to FIG. 25, shown therein is a diagram of an exemplary embodiment of a connection augmentation workflow constructed in accordance with the present disclosure. Shows that the system supports adding AI augmentation to connection types as well as element types. The connection augmentation workflow may be the same as for any of the one or more model components, including model element. The SME 100 may hover over an element connection type in the model builder and AI augmentation user interface 400 to cause the processing component 92 to expose the popup menu 800 that, upon selection of a particular menu item, may cause the processing component 92 to display the connection type configuration UI 910 for editing the definition of the connection type (action 2500), the connection type configuration UI 910 that is launched by the processing component may include an prompt template input 2502 for adding one or more AI augmentation prompt templates (action 2505), those prompt templates, when executed by the processing component from an augmentation entry point, either from the model builder and AI augmentation user interface 400 or the view of the model data (e.g., named view 1700), are converted by the processing component 92 to dynamic prompts using data from the augmentation entry point (action 2510), are sent to the AI services 178 via coordinated call packages (CCPs) across the network 96, and the processing component 92 displays the service results on the user device 98 for import into the data model (action 2515), so that after import into the data model, the SME 100 can continue reviewing the results (e.g., step 250, FIG. 2) with the benefit of newly augmented connection instances (action 2520).

In the example used in FIG. 25, a connection type 2550 between the “Research Areas” component type 1010g and the “Algorithms” component type 1010e has been added in order to cause the processing component 92 to execute the AI augmentation to determine if one or more of the “Research Areas” element instances created by the service responses might already be using advanced versions of those algorithms (of the “algorithms” component type 1010e) to solve current research challenges faced as determined in the “research areas” component type 1010g. The named view 1700c shows that the “Hierarchical Pathfinding” element instance 2315 of the “algorithms” element type appears to already be used in instances of the “Research Area” element instance of “Transportation Engineering” (element instance 2325), but that no connection instances have been added between “Hierarchical Pathfinding” element instance 2315 and “Telecommunication Engineering” element instance 2330 or “Environmental Science” element instance 2335, thereby increasing certainty that the research challenge exaptations illuminated may in fact be quite novel.

Referring now to FIGS. 26A-B, shown therein are diagrams of exemplary embodiments of a second model 2600 and a named view 2605 associated with the second model 2600 constructed in accordance with the present disclosure. The second model 2600 may be a model different from the first model 1000 created by the SME 100 to explore a very different complex phenomena. The second model 2600 may have a first model element 2601a with a “geographical locations” element type, a second model element 2601b having an “Indian Businesses” element type, a third model element 2601c having a “Business Schools” element type, and a fourth model element 2601d having a “Christian Concepts” element type. In this way, the second model 2600 explores how Indian businesses (the second model element 2601b) may be unknowingly shaped (element connection) by Christian concepts (the fourth model element 2601d) as a result of their past and present leadership attending mostly western business schools (the third model element 2601c) that were founded by Christians.

Unlike the video game algorithm example of the first model 1000 discussed above, the SME 100 in this case did not seed the second model 2600 with any model data, but instead interacted with the user device 98 to cause the processing component 92 to launch the AI augmentation using the “Indian Businesses” element type as the starting augmentation entry point. The SME 100 then viewed the service results and expanded the AI augmentation of the second model 2600 based on areas of interest (shown in the named view 2605). Similar to how the example of FIG. 24 maintained context and state, the named view 2605 also shows the awareness of the second model 2600 within which the AI augmentation is operating: The Indian business “Wipro” (element instance 2610) might be influenced by Harvard Business School (element instance 2615) because its former Chairman, Azim Premji, attended, as described in description 2616. Thus, it may be possible that Wipro's focus on social responsibility (element instance 2625) could be seen as being informed by Harvard Business School's emphasis on community engagement (element instance 2620) which may have been informed by “Christian teachings of love for neighbor and helping those in need,” as described in description 2622.

In one embodiment, use of the IA mixed-structure system 90, when applied to complex humanities phenomena, may produce ideas harder to validate or test than when applied to science and engineering phenomena like the algorithmic exaptation example above, but the IA mixed-structure system 90 is agnostic to which domain model the IA mixed-structure system 90 is being applied within and at which problem within that domain model the IA mixed-structure system 90 is being aimed. In this way, the IA mixed-structure system 90 augments the intelligence of the SMEs, i.e., human subject matter experts, the IA mixed-structure system 90 does not replace SMEs.

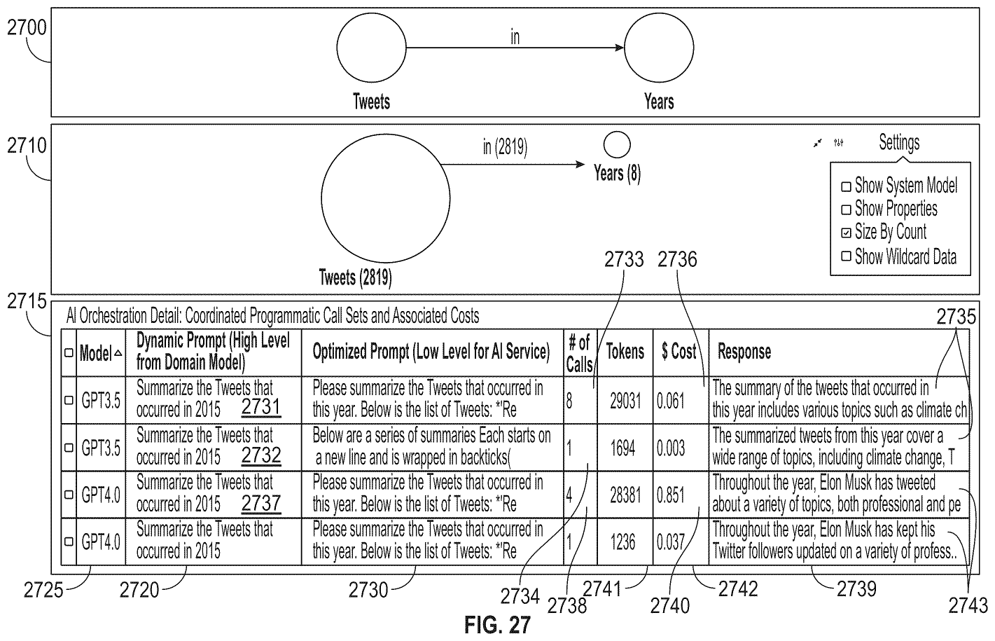

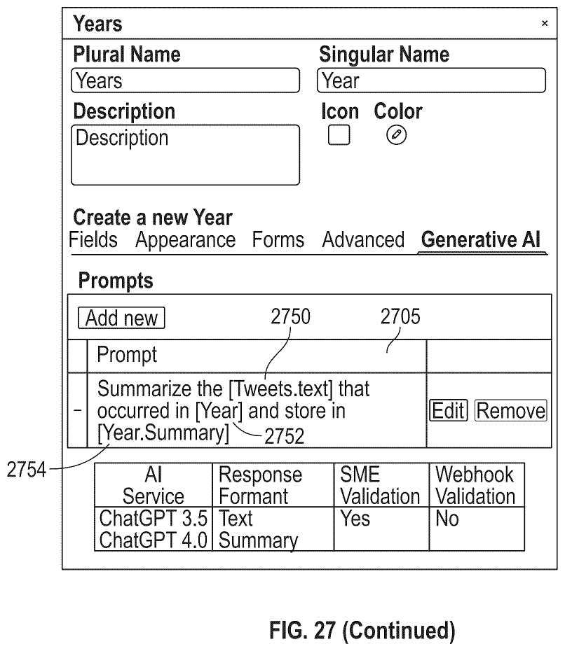

Referring now to FIG. 27, shown therein is an illustration of an exemplary embodiment of a user interface showing construction, execution, and associated costs of a coordinated call package (CCP) constructed in accordance with the present disclosure. As shown, the processing component 92 performs a number of steps to convert the prompt template to a coordinated call package (CCP) as a result of limitations with the AI service 178 being called. A first model view 2700 contains tweets for different years. Sizing the first model view 2700 by a quantity of data elements (model data) contained within each model element instance results in a second model view 2710, which indicate that there are 2,819 tweets across 8 different years. For each “Year,” an AI augmentation prompt template 2705 having prompt text: “Summarize the [Tweets.text] that occurred in [Year] and store in [Year.Summary]” has three placeholders, a “Tweets.text” placeholder 2750, a “Year” placeholder 2752, and a “Year.Summary” placeholder 2754.

As shown in FIG. 27, the large number of tweets returned result in a text payload larger than the maximum payload size of the AI services 178 (e.g., GPT3.5 and GPT4.0) API. Thus, the AI services 178 are not able to receive the entire text payload in a single API call. Therefore, the processing component 92 executing the AI augmentation engine 160 produces two coordinated call packages in order to achieve the request, with one CCP for GPT3.5 and one CCP for GPT4.0, and uses each CCP to execute a series of API calls to each of the AI Services 178 to execute a “summary of summaries” API calling strategy (as described above in relation to FIG. 3) that stays within the maximum payload size of the API for each service. Because the AI services 178 perform differently from one another and have different maximum payload size limitations, the CCPs are different.

In one embodiment, tweets are sent in batches that stay within the maximum payload sizes along with a prompt 2731 to summarize the tweets in each batch. For GPT3.5, eight (8) calls were required to transmit all the tweets (as indicated by call count 2733). The processing component 92 stores the summaries returned from each of the 8 calls in the memory 94 and constructs another prompt 2732 in which the AI service 178 is asked to summarize the summaries. This second summarization is accomplished in a single call as indicated by call count 2734.

The same strategy is performed for GPT4.0 (e.g., by the processing component 92 generating a prompt 2737) but, because GPT4.0 has a larger maximum API payload size, the GPT4.0 AI service requires only 4 calls to summarize the tweets and 1 call to summarize the summaries (as indicated by the call counts 2738). Table 2715 also illustrates a capability of the AI augmentation engine 160 to record metadata about the CCPs (e.g., augmentation calls), including cost data 2736 and cost data 2740. In the table 2715, each dynamic prompt (shown in column 2720) is recorded (e.g., saved by the processing component 92 in the memory 94), along with all the optimized prompts that were created (shown in column 2730), the AI service 178 to which those optimized prompts were sent (shown in column 2725), raw responses back from the AI services 178 (shown in column 2739), and costs associated, both in the form of text tokens sent (shown in column 2741) and dollars spent (shown in column 2742) to send that number of tokens. In this way, the table 2715 allows the SME 100 to see differences in the cost of using different AI services 178. GPT3.5's responses (rows 2735 of the column 2742) cost a total of 6 cents, while GPT4.0's responses (rows 2743 of the column 2742) cost a total of 89 cents—more than 10× more than GPT3.5's response cost.

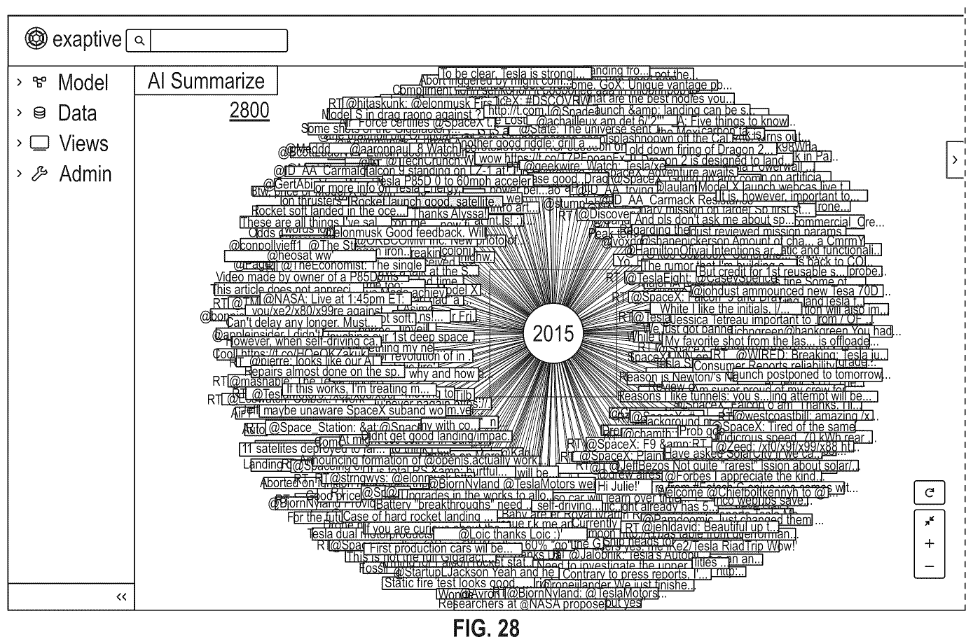

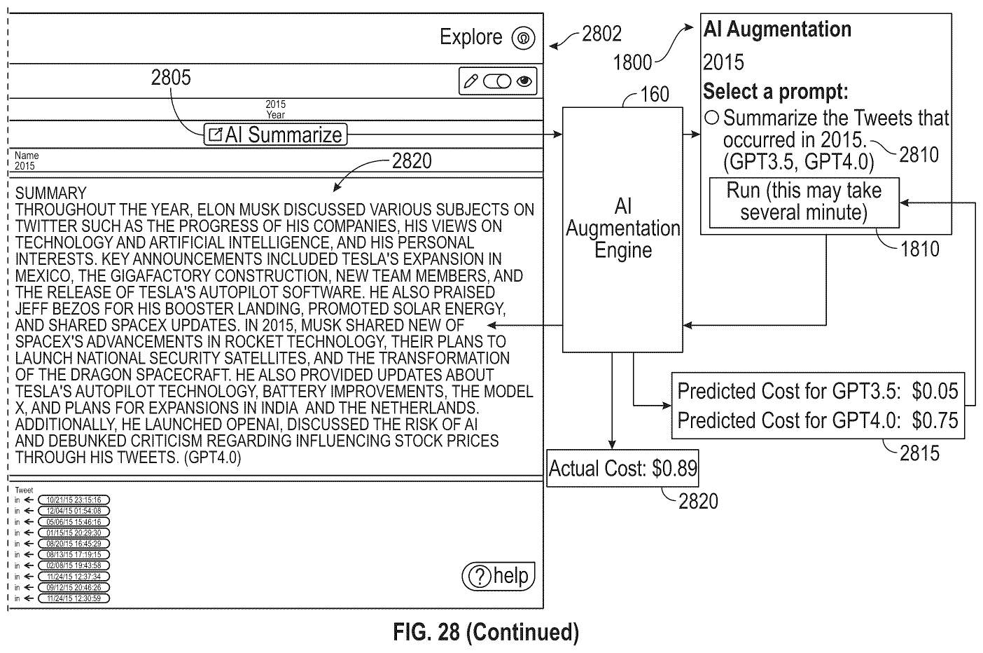

Referring now to FIG. 28, shown therein is a workflow diagram of an exemplary embodiment of a fourth view 2800 after AI augmentation described above in relation to FIG. 27 and constructed in accordance with the present disclosure. As shown in the fourth view 2800, tweets for particular years are shown, the SME 100 may select the year “2015” which causes the processing component 92 to open a right side-panel 2802 containing an “AI Summarize” button 2805. The SME 100 may interact with the “AI summarize” button 2805, which causes the processing component 92 to execute the AI augmentation engine 160 which allows the SME 100 to select a dynamic prompt 2810 to execute. Upon selection of the run button 1810, the processing component 92 executing the AI augmentation engine 160 converts the selected dynamic prompt 2810 into a set of coordinated call packages CCPs which each have a predicted cost 2815 based on the AI service 178 to which the CCPs will be sent.

In one embodiment, the processing component 92 may present the predicted cost 2815 to the SME 100 via the user device 98 (and may present to the user device 98 an input to allow the SME 100 to approve or reject transmission of the CCPs on an AI Service-by-AI service basis. In some embodiments, if the SME 100 rejects the CCPs, the processing component 92 may return the SME 100 to the AI augmentation UI 1800 so the SME 100 can adjust/alter the dynamic prompt 2810; the AI services 178 to which the dynamic prompt 2810 will be sent; and/or the CCP methodology employed (e.g., a greater number of calls resulting in a more accurate response but an increased cost, or a lesser number of calls resulting in a less accurate response but at a decreased cost). Because the cost of the AI augmentation may be affected by the size of the service responses from individual calls in the CPP that are then sent back to the AI service 178 in subsequent calls of the CCP, an actual cost 2820 of an AI augmentation may differ from the predicted cost 2815.

In this way, as shown in FIGS. 27-28, the IA mixed-structure system 90 disclosed herein contains a critical abstraction layer between the “prompt” as the SME 100 perceives it and the “prompt” as the AI Services 178 receives it, as well as between the “[service] responses” as the AI service 178 returns to the IA mixed-structure system 90 and the “responses” that the SME 100 receives and/or views. This unique and unconventional arrangement of the IA mixed-structure system 90 being interposed between the SME 100 and the AI services 178 enables the IA mixed-structure system 90 to be mixed-structure and domain agnostic. Thus, the processing component 92 executing the AI augmentation engine 160 enables the processing component 92 to:
Use one or more optimized prompts based on SME-written prompt templates, by first converting the SME-written prompt templates into data-driven dynamic prompts that can access a multitude of model data from the model based on the syntax of the SME-written prompt template combined with the selected augmentation entry point;
Orchestrate (via execution of the orchestration engine 165) one or more coordinated calls (CCPs) containing the optimized prompts to one or more AI services 178;
Use intermediate storage, aggregation, and manipulation of the incremental service responses to the optimized prompts in order to form a complete answer for the data-driven SME-written prompt; and
Parse the completed answer into an arbitrary number of structured formats such as name/description pairs, long text summaries, single numeric values, etc., based on the field definitions 125 contained within the SME model 110 and the configuration settings associated with the AI augmentation prompt templates0

Referring now to FIG. 29, shown therein is a hardware diagram of an exemplary embodiment of the user device 98 of the IA mixed-structure system 90 constructed in accordance with the present disclosure. In some embodiments, the user device 98 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the user device 98 may include one or more input device 2900 (hereinafter “input device 2900”), one or more output device 2904 (hereinafter “output device 2904”), one or more processing component 2908 (hereinafter “processing component 2908”), one or more communication device 2912 (hereinafter “communication device 2912”) capable of interfacing with the network 96, one or more memory 2916 (hereinafter “memory 2916”) storing processor-executable code and/or application(s) 2920 (hereinafter “user application 2920”). The user application 2920 may include, for example, a web browser capable of accessing a website and/or communicating information and/or data over a wireless or wired network (e.g., the network 96), and/or the like. The input device 2900, output device 2904, processing component 2908, communication device 2912, and memory 2916 may be connected via a path 2924 such as a data bus that permits communication among the components of the user device 98.

The memory 2916 may be one or more non-transitory processor-readable medium. The memory 2916 may store the user application 2920 that, when executed by the processing component 2908, causes the user device 98 to perform an action such as communicate with or control one or more component of the user device 98 and/or, via the network 96, the IA mixed-structure system 90. The memory 2916 may be one or more memory 2916 working together, or independently, to store processor-executable code and may be located locally or remotely, e.g., accessible via the network 96.

The input device 2900 may be capable of receiving information input from the SME 100 and/or processing component 2908, and transmitting such information to other components of the user device 98 and/or the network 96. The input device 2900 may include, but is not limited to, implementation as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example.

The output device 2904 may be capable of outputting information in a form perceivable by the SME 100 and/or processing component 2908. Implementations of the output device 2904 may include, but are not limited to, a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and the like, for example. It is to be understood that in some exemplary embodiments, the input device 2900 and the output device 2904 may be implemented as a single device, such as, for example, a touchscreen of a computer, a tablet, or a smartphone. It is to be further understood that as used herein the term SME (e.g., the SME 100) is not limited to a human being, and may comprise a computer, a server, a website, a processor, a network interface, a user terminal, a virtual computer, combinations thereof, and/or the like, for example. The output device 2904 may display the primary user interface 99 on the user device 98.

The network 96 may permit bi-directional communication of information and/or data between the user device 98 and/or the IA mixed-structure system 90. The network 96 may interface with the IA mixed-structure system 90 and/or the user device 98 in a variety of ways. For example, in some embodiments, the network 96 may interface by optical and/or electronic interfaces, and/or may use a plurality of network topographies and/or protocols including, but not limited to, Ethernet, TCP/IP, circuit switched path, combinations thereof, and/or the like, as described above.

Exemplary embodiments of the processing component 2908 may include, but are not limited to, a processor, a microprocessor, a mobile processor, a system on a chop (SoC), a central processing unit (CPU), a microcontroller (MCU), a digital signal processor (DSP), an application specific integrated circuit (ASIC), a field programmable gate array (FPGA), a Tensor Processing Unit (TPU), a graphics processing unit (GPU), a combination of hardware and software, and/or the like. The processing component 2908 may be capable of communicating with the memory 2916 via the path 2924 (e.g., data bus). The processing component 2908 may be capable of communicating with the input device 2900 and/or the output device 2904. The processing component 2908 may include one or more processing component 2908 working together, or independently, and located locally, or remotely, e.g., accessible via the network 96.

The number of devices and/or networks illustrated in FIG. 29 is provided for explanatory purposes. In practice, there may be additional devices and/or networks, fewer devices and/or networks, different devices and/or networks, or differently arranged devices and/or networks than are shown in FIG. 29. Furthermore, two or more of the components or devices illustrated in FIG. 29 may be implemented within a single device, or a single device illustrated in FIG. 29 may be implemented as multiple, distributed devices/components. Additionally, or alternatively, one or more of the devices of the user device 98 may perform one or more functions described as being performed by another one or more of the devices of the user device 98. Devices of the IA mixed-structure system 90 may interconnect via wired connections, wireless connections, or a combination thereof. For example, in one embodiment, the user device 98 and the IA mixed-structure system 90 may be integrated into the same device, that is, the user device 98 may perform functions and/or processes described as being performed by the IA mixed-structure system 90, described above in more detail.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A computer system, comprising:
a processing component operable to communicate with a user device having a primary user interface; and
a memory comprising one or more non-transitory processor-readable medium storing processor-executable instructions that when executed by the processing component cause the processing component to:
receive a model definition for a domain model, the model definition comprising a first plurality of model components having one or more field definitions, the first plurality of model components including a first model element type, a second model element type, and a connection type, the connection type being a relationship between the first model element type and the second model element type;
associate the one or more model components with at least one prompt template having a text template and containing one or more placeholders, each placeholder being associated with at least one of: a particular model component of the one or more model components, one or more field definitions of the particular model component, and a placeholder value;
associate the at least one prompt template with an AI integration definition, the AI integration definition linking the at least one prompt template to one or more artificial intelligence services, and having one or more prompt settings associated with one or more service responses from the one or more artificial intelligence services, the one or more prompt settings including a response format, a response validation, and a response storage;
receive first model data associated with at least one of the first plurality of model components of the model definition of the domain model as one or more component instances of the domain model;
display, on the primary user interface of the user device, a view having a property-graph-based representation of the one or more component instances of the domain model;
receive an augmentation entry point indicative of: at least one of the first plurality of model components or at least one of the one or more component instances;
construct, in response to an augmentation message, one or more dynamic prompts based on the at least one prompt template associated with the augmentation entry point, by substituting the one or more placeholders within the at least one prompt template with data from one or more of:
the first plurality of model components, the one or more component instances, and the placeholder value based at least in part on the one or more prompt settings;
orchestrate, based on the one or more dynamic prompts and the AI integration definition, creation of one or more coordinated call package, each coordinated call package containing one or more service calls to the one or more artificial intelligence services linked by the AI integration definitions, each of the one or more service calls containing an optimized prompt and an optimized data payload based on: requirements of the one or more artificial intelligence services being called, and settings of the AI integration definition, and each coordinated call package containing parsing and aggregating settings, the parsing and aggregating settings including a structured format aligned to the model definition;
receive a service response resulting from the execution of the one or more coordinated call packages by the one or more artificial intelligence services, the service response having the response format;
parse the service response having the response format into a structured response having the structured format;
generate an augmented model data based on the first model data updated to include the structured responses and based on the model definition for the domain model; and
augment, on the primary user interface of the user device, the one or more component instances of the domain model in the property-graph-based representation of the view with the augmented model data.

2. The computer system of claim 1, wherein the memory further includes instructions that when executed by the processing component, cause the processing component to:
display, on the primary user interface of the user device, a model builder user interface operable to receive an add input from a subject matter expert; and
in response to receiving the add input, update the model definition to include one or more of: a third model element and a second element connector.

3. The computer system of claim 2, wherein the memory further includes instructions that when executed by the processing component, cause the processing component to:
display, on the primary user interface of the user device, the model builder user interface further operable to receive a selection of an augmentation entry point from a subject matter expert, the augmentation entry point being indicative of selection of the domain model instance as the augmentation entry point.

4. The computer system of claim 1, wherein the memory further includes instructions that when executed by the processing component, cause the processing component to:
display, on the primary user interface of the user device, a model builder user interface operable to receive a selection of the augmentation entry point from a subject matter expert, the augmentation entry point being indicative of selection of the one or more component instances of the first domain model instance as the augmentation entry point.

5. The computer system of claim 1, wherein the memory further includes instructions that when executed by the processing component, cause the processing component to:
display, on the primary user interface and prior to replacing the one or more component instance, an SME validation interface operable to receive one or more validation input from a subject matter expert indicative of an acceptance of the second domain model instance having the augmented model data; and
storing the augmented model data of the second domain model instance in a model data storage of the memory.

6. The computer system of claim 1, wherein the memory further includes instructions that when executed by the processing component, cause the processing component to:
validate the second domain model instance having the augmented model data using one or more validation function based on the response validation by sending the second domain model instance having the augmented model data to a validation endpoint;
receive an autovalidated response having the second domain model instance with a validated augmented model data;
display, on the primary user interface and prior to replacing the one or more component instance, an SME validation interface operable to receive one or more validation input from a subject matter expert indicative of an acceptance of the second domain model instance having the validated augmented model data; and
storing the validated augmented model data of the second domain model instance in a model data storage of the memory.

7. The computer system of claim 1, wherein the placeholder value is one of a dynamically computed variable and a static value.

8. A computer system, comprising:
a processing component operable to communicate with a user device having a primary user interface; and
a memory comprising one or more non-transitory processor-readable medium storing processor-executable instructions that when executed by the processing component cause the processing component to:
display, on the primary user interface of the user device, a domain model having a property-graph-based representation of a domain model definition of a domain model, the domain model definition comprising a first plurality of model components having one or more field definitions, the first plurality of model components including a first model element type, a second model element type, and a connection type, the connection type being a relationship between the first model element type and the second model element type, the property-graph representation having component instances including a first model element instance based on the first model element type, a second model element instance based on the second model element type, and a connection instance based on the connection type;
receive an augmentation entry point indicative of at least one of the first plurality of model components or at least one of the component instances;
construct, in response to an augmentation message, one or more dynamic prompts based on at least one prompt template associated with the augmentation entry point, by substituting one or more placeholders within the at least one prompt template with data from one or more of: the first plurality of model components or the one or more component instances;
orchestrate, based on the one or more dynamic prompts, creation of one or more coordinated call package, each coordinated call package containing one or more service calls to one or more artificial intelligence services, each of the one or more service calls containing an optimized prompt and an optimized data payload based on: requirements of the one or more artificial intelligence services being called, and each coordinated call package containing parsing and aggregating settings, the parsing and aggregating settings including a structured format aligned to the domain model definition;
receive a service response resulting from the execution of the one or more coordinated call packages by the one or more artificial intelligence services, the service response having a response format;
parse the service response having the response format into a structured response having a structured format;
generate an augmented model data based on the first model data updated to include the structured response and based on the model definition for the domain model; and
augment, on the primary user interface of the user device, the component instances of the domain model with the augmented model data.
